(19) United States
(12) Patent Application Publication
(10) Pub. No.: US 2026/0361961 A1
(43) Pub. Date: Nov. 12, 2026

(54) GENERATING RECOMMENDATIONS AND FORECASTING DEMAND FOR PRELAUNCH MEDIA CONTENT

(71) Applicant: NETFLIX, INC., Los Gatos, CA (US)

(72) Inventors: Aliki Mavromoustaki MADDOCK, Los Angeles, CA (US); Yunan HU, New York, NY (US); Mark Andrew THORNBURG, Seattle, WA (US); Mario GARCIA ARMAS, Blaine, WA (US); Vito Claudio OSTUNI, Belmont, CA (US); Anne O'Donnell COCOS, Swarthmore, PA (US); Kriti Kohli NELSON, New York, NY (US); Christoph KOFLER, Los Gatos, CA (US); Robert SALTIEL, Los Angeles, CA (US)

(21) Appl. No.: 19/668,681

(22) Filed: May 5, 2026

Related U.S. Application Data
(60) Provisional application No. 63/802,925, filed on May 9, 2025.

(51) Int. Cl. H04N 21/466; H04N 21/2385; H04N 21/442

(52) U.S. Cl. CPC H04N 21/4668; H04N 21/2385; H04N 21/44204

(57) ABSTRACT

Techniques for generating content delivery network (CDN) resource plans includes receiving one or more prelaunch interaction signals associated with one or more prelaunch content items, generating, via a trained machine learning model, an at-launch demand forecast based on at least the one or more prelaunch interaction signals, adjusting the at-launch demand forecast based on at least one or more historical similar events and one or more domain heuristics to generate an adjusted demand forecast, generating, based on at least the adjusted demand forecast, a CDN resource plan, and allocating one or more CDN resources based on at least the CDN resource plan.

### CROSS-REFERENCE TO RELATED APPLICATIONS

This application claims priority benefit of the United States Provisional patent application titled, “TECHNIQUES FOR GENERATING RECOMMENDATIONS FOR NEW CONTENT TYPES,” filed on May 9, 2025, and having Ser. No. 63/802,925. The subject matter of this related application is hereby incorporated herein by reference.

### BACKGROUND

### Technical Field

The embodiments of the present disclosure relate generally to computer science and signal processing, and more specifically, to generating recommendations and forecasting demands for prelaunch media content.

### Description of the Related Art

Content recommendation systems can deliver personalized content to members based on member interactions, member preferences, and content characteristics. Content recommendation systems are widely used across digital platforms, including video streaming services, online news portals, and e-commerce platforms, to improve member engagement and member satisfaction. For example, in video streaming services, content recommendation systems analyze member behavior, such as viewing history, clicks, and other engagement signals, in combination with content representations (e.g., embeddings and metadata), to rank and present content that is likely to be relevant to a given member. Content recommendation systems often employ machine learning models to process large volumes of interaction data and generate ranked lists of content items for presentation in user interfaces.

To generate recommendations, conventional content recommendation systems use a variety of recommendation techniques. One conventional approach is content-based filtering, which involves recommending content items similar to content items associated with prior member interactions or prior member preferences. For example, a member who has watched several science fiction movies could receive recommendations for other science fiction content items. Content-based filtering is based on attributes of content items, such as genre, actors, directors, and/or similar attributes, and historical interactions associated with such attributes. Another conventional approach is collaborative filtering, which recommends media content that is popular among similar members. For example, in a streaming service, a feature such as “viewers who watched this also watched” is based on collaborative filtering, where a content recommendation system suggests movies or TV shows based on viewing patterns of other members with similar tastes. Although such approaches can be effective when sufficient historical usage data is available, their performance depends on informative interaction data and sufficiently rich content representations.

Despite the widespread use of such recommendation techniques, conventional content recommendation systems are not well suited to handle newly introduced content or prelaunch content (e.g., a content item that has not yet become available for viewing by members and is associated with a future launch time) for which little or no historical interaction data is available. For example, content-based filtering relies on existing content attributes and prior member interactions, while collaborative filtering depends on interaction patterns from similar members. For new content or prelaunch content, such interaction signals could be sparse or entirely unavailable, which hinders conventional content recommendation systems from accurately estimating relevance. In such settings, conventional systems can be forced to rely on limited metadata or weak proxy signals, which can reduce data richness and increase ranking error. Further, conventional recommendation systems often do not effectively incorporate prelaunch interaction signals, such as clicks, reminder registrations, or watchlist additions, or account for changes in member interest as a launch time approaches. As a result, conventional content recommendation systems often fail to effectively recommend new content or upcoming content to members.

In addition to affecting content recommendation, the challenges associated with new content and prelaunch content also affect demand forecasting in large-scale content delivery systems. In particular, anticipated member interest in a content item can affect operational planning and resource allocation. Accordingly, demand forecast systems are used to forecast expected member activity and allocate computing resources and network resources accordingly. Demand forecast systems are used in applications involving large-scale content delivery, such as streaming services, where member demand can vary over time. For example, in video streaming systems, forecasting models can estimate expected viewership for a content item over a specified time horizon based on historical usage patterns, content attributes, and other contextual signals. Based on the expected viewership, resource allocation systems can allocate resources, such as network bandwidth, server capacity, and content delivery network (CDN) resources, to ensure reliable and high-quality content delivery.

As with conventional content recommendation systems, conventional demand forecasting systems often rely on historical usage data and statistical models or machine learning models to predict future demand. For example, time-series forecasting models can use past viewership trends, seasonal patterns, and known events to estimate expected member activity over a future time horizon. In some cases, regression-based models or heuristic rules are used to estimate peak demand and guide resource allocation decisions. However, such a reliance on historical usage data can make conventional demand forecasting systems less effective for new content or prelaunch content. For example, time-series forecasting models and regression-based approaches typically estimate future demand based on past viewership trends, seasonal patterns, and known historical events. Such approaches may not adequately capture changes in member interest associated with new content or prelaunch content, may not effectively use prelaunch interaction signals, and can have reduced accuracy for content types having different demand dynamics, such as live events relative to on-demand content. As a result, demand forecasts for new content or prelaunch content items can be inaccurate, which can lead to suboptimal allocation of network bandwidth, server capacity, and CDN resources.

As the foregoing illustrates, what is needed in the art are more effective techniques for prelaunch content recommendation and demand forecasting.

### SUMMARY

One embodiment of the present disclosure includes a method for generating recommendations for prelaunch content. The method includes performing, via one or more trained machine learning models, one or more operations to generate one or more prelaunch labels and one or more anticipation rewards based on at least one or more first cross content member interactions. The method further includes performing, based on at least the one or more prelaunch labels, the one or more anticipation rewards, and the one or more first cross content member interactions, one or more training operations to retrain the one or more trained machine learning models to generate one or more retrained machine learning models. Furthermore, the method includes generating, via the one or more retrained machine learning models, one or more first prelaunch content recommendations based on at least one or more second cross content member interactions.

Another embodiment of the present disclosure includes a method for generating content delivery network (CDN) resource plans. The method includes receiving one or more prelaunch interaction signals associated with one or more prelaunch content items. The method also includes generating, via a trained machine learning model, an at-launch demand forecast based on at least the one or more prelaunch interaction signals. The method further includes adjusting the at-launch demand forecast based on at least one or more historical similar events and one or more domain heuristics to generate an adjusted demand forecast. In addition, the method includes generating, based on at least the adjusted demand forecast, a CDN resource plan. Furthermore, the method includes allocating one or more CDN resources based on at least the CDN resource plan.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques enable accurate recommendation and demand forecasting for newly introduced or prelaunch content by leveraging prelaunch interaction signals and time-dependent modeling. In particular, the disclosed techniques utilize prelaunch interaction signals, such as clicks, reminder registrations, and watchlist additions, together with content embeddings, member metadata, and cross content member interactions to train ranking models using anticipation rewards that account for temporal proximity to a launch time. Therefore, the disclosed techniques infer user interest for prelaunch content even in the absence of historical usage data and can adapt to distributional shifts associated with new content types, such as live events relative to on-demand content.

Another advantage of the disclosed techniques relative to prior art is that the disclosed techniques incorporate prelaunch interaction signals into demand estimation models to forecast viewership prior to content availability, which enables more accurate demand forecasting relative to approaches that rely solely on historical usage data. By combining model-based predictions with temporal weighting, quantile-based forecasting, historical-event adjustments, and domain-informed adjustments, the disclosed techniques improve the accuracy and robustness of demand forecasts and enable proactive allocation of CDN resources. Further, because the disclosed techniques generate demand features using aggregated prelaunch interaction signals and metadata rather than requiring large volumes of post-launch usage data, the disclosed techniques reduce computational complexity and enable demand forecasts to be generated more efficiently. Additionally, by allocating CDN resources prior to launch based on the demand forecasts, the disclosed techniques reduce over-provisioning and under-provisioning of network bandwidth, server capacity, and edge node resources, improve geographic distribution of CDN resources, and reduce latency, buffering, and network congestion during presentation of prelaunch content items.

These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure;

FIG. 2 is a block diagram of a content server that can be implemented in conjunction with the network infrastructure of FIG. 1, according to various embodiments of the present disclosure;

FIG. 3 is a block diagram of a control server that can be implemented in conjunction with the network infrastructure of FIG. 1, according to various embodiments of the present disclosure;

FIG. 4 is a block diagram of an endpoint device that can be implemented in conjunction with the network infrastructure of FIG. 1, according to various embodiments of the present disclosure;

FIG. 5 is a block diagram of a computer-based system according to various embodiments;

FIG. 6 is a more detailed illustration of the training data generator of FIG. 5, according to various embodiments;

FIG. 7 is a more detailed illustration of the model trainer of FIG. 5 training the ranking models of FIG. 5, according to various embodiments;

FIG. 8 is a more detailed illustration of the prelaunch content recommendation application of FIG. 5, according to various embodiments;

FIG. 9A is a more detailed illustration of the content delivery network (CDN) resource allocator of FIG. 5, according to various embodiments;

FIG. 9B is a more detailed illustration of the model trainer of FIG. 5 training the at-launch demand forecast model of FIG. 5, according to various embodiments;

FIG. 10 sets forth a flow diagram of method steps for generating training data, according to various embodiments;

FIG. 11 sets forth a flow diagram of method steps for training ranking models, according to various embodiments;

FIG. 12 sets forth a flow diagram of method steps for generating prelaunch content recommendations, according to various embodiments;

FIG. 13 sets forth a flow diagram of method steps for generating allocated CDN resources, according to various embodiments; and

FIG. 14 sets forth a flow diagram of method steps for training an at-launch demand forecast model, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

Conventional content recommendation systems and demand forecast systems are generally designed for content items that already have sufficiently rich historical usage data. For example, conventional content recommendation systems typically employ content-based filtering or collaborative filtering techniques that rely on prior member interactions, historical engagement signals, or interaction patterns of similar members to estimate relevance. Likewise, conventional demand forecast systems often employ time-series forecasting models, regression-based models, or heuristic rules that rely on historical viewership trends, seasonal patterns, and historical launch behavior to estimate future demand and allocate computing resources and network resources. However, such approaches are not well suited for newly introduced content or prelaunch content, particularly live events, because little or no historical interaction data is available before launch. As a result, conventional systems are often forced to rely on limited metadata or weak proxy signals, which reduces the richness of the input data and increases ranking error and forecasting error. Further, conventional content recommendation systems often do not effectively incorporate prelaunch interaction signals, such as clicks, reminder registrations, and watchlist additions, or account for changes in member interest as a launch time approaches. Consequently, conventional systems frequently fail to accurately infer member interest, recommend new content or upcoming content, or forecast expected member activity, which can in turn lead to inefficient allocation of network bandwidth, server capacity, and content delivery network (CDN) resources, including over-allocation or under-allocation of CDN resources for content types having different demand dynamics, such as live events relative to on-demand content.

To address the foregoing issues, the disclosed embodiments provide techniques for generating recommendations and forecasting demands for prelaunch content. The disclosed techniques include one or more ranking models. Each of the one or more ranking models is a trained machine learning model that processes one or more prelaunch features and generates one or more ranking scores. In some embodiments, a training data generator processes upcoming live title metadata, content metadata, one or more content embeddings, one or more first cross content member interactions, and member metadata and generates one or more first candidate live titles, one or more prelaunch labels, and one or more anticipation rewards. The training data generator includes a prelaunch title detector, a candidate title generator, a prelaunch feature generator, a prelaunch content recommender, a prelaunch label generator, and an anticipation reward calculator. The prelaunch title detector detects one or more prelaunch live titles based on the upcoming live title metadata. The candidate title generator processes the prelaunch live titles, the first cross content member interactions, and the content embeddings and generates one or more first candidate live titles. The prelaunch feature generator processes the first candidate live titles, the first cross content member interactions, the content embeddings, the content metadata, and the member metadata and generates one or more first prelaunch features. The prelaunch content recommender uses the ranking models to process the first prelaunch features and the first candidate live titles and generates one or more first prelaunch content recommendations. The prelaunch label generator processes the first prelaunch content recommendations and one or more first prelaunch interaction signals and generates the prelaunch labels. The anticipation reward calculator processes the prelaunch labels and the content metadata and generates the anticipation rewards.

In some embodiments, a model trainer retrains the ranking models based on the content metadata, the member metadata, the content embeddings, the first cross content member interactions, the first candidate live titles, the prelaunch labels, and the anticipation rewards. During the retraining, the prelaunch feature generator processes the content metadata, the content embeddings, the first cross content member interactions, the member metadata, and the first candidate live titles and generates one or more second prelaunch features. The ranking models process the second prelaunch features and generate one or more ranking scores. A loss calculator calculates a first loss based on the ranking scores, prelaunch labels, and anticipation rewards. The model trainer uses the first loss to iteratively update one or more parameters of the ranking models until one or more stopping criteria are met. Once retrained, the retrained ranking models can be used via a prelaunch content recommendation application to generate one or more second prelaunch recommendations based on the member metadata, the content metadata, the content embeddings, one or more second cross content member interactions, and one or more second candidate live titles.

In some embodiments, a CDN resource allocator uses an at-launch demand forecast model to process one or more second prelaunch interaction signals, the upcoming live title metadata, one or more historical similar events, one or more domain heuristics, and a CDN configuration and generates one or more allocated CDN resources. The at-launch demand forecast model is a trained machine learning model that processes one or more demand features and generates an at-launch demand forecast. In some embodiments, the CDN resource allocator includes a demand feature generator, an at-launch demand forecast module, an adjusted demand forecast generator, a CDN resource plan generator, and a CDN resource allocator. The demand feature generator processes the second prelaunch interaction signals and the upcoming live title metadata and generates the demand features. The at-launch demand forecast module uses the at-launch demand forecast model to process the demand features and generates the at-launch demand forecast and an at-launch demand distribution. The adjusted demand forecast generator processes the historical similar events and the domain heuristics and generates an adjusted demand forecast. The CDN resource plan generator processes the adjusted demand forecast and the CDN configuration and generates a CDN resource plan. The CDN resource allocator allocates CDN resources to live titles included in the upcoming live title metadata based on the CDN resource plan to generate the allocated CDN resources.

In some embodiments, the model trainer retrains the at-launch demand forecast model based on live launch telemetry and the at-launch demand forecast. During the retraining, a post-launch demand and quality of experience (QoE) metrics calculator calculates one or more post-launch demand and QoE metrics based on the live launch telemetry. The loss calculator calculates a second loss based on the at-launch demand forecast and the post-launch demand and QoE metrics. The model trainer updates one or more parameters of the at-launch demand forecast model based on the second loss.

At least one technical advantage of the disclosed techniques relative to prior art is that the disclosed techniques enable accurate recommendation and demand forecasting for newly introduced or prelaunch content by leveraging prelaunch interaction signals and time-dependent modeling. In particular, the disclosed techniques utilize prelaunch interaction signals, such as clicks, reminder registrations, and watchlist additions, together with content embeddings, member metadata, and cross content member interactions to train ranking models using anticipation rewards that account for temporal proximity to a launch time. Therefore, the disclosed techniques infer user interest for prelaunch content even in the absence of historical usage data and can adapt to distributional shifts associated with new content types, such as live events relative to on-demand content.

Another advantage of the disclosed techniques relative to prior art is that the disclosed techniques incorporate prelaunch interaction signals into demand estimation models to forecast viewership prior to content availability, which enables more accurate demand forecasting relative to approaches that rely solely on historical usage data. Further, by generating prelaunch content recommendations that increase prelaunch member engagement, the disclosed techniques increase the quantity and quality of prelaunch interaction signals available for demand estimation, thereby further improving forecast accuracy. By combining model-based predictions with temporal weighting, quantile-based forecasting, historical-event adjustments, and domain-informed adjustments, the disclosed techniques improve the accuracy and robustness of demand forecasts and enable proactive allocation of CDN resources. More accurate demand forecasts, together with the domain-informed adjustments, further enable improved orchestration, provisioning, and operational planning for live events. Further, because the disclosed techniques generate demand features using aggregated prelaunch interaction signals and metadata rather than requiring large volumes of post-launch usage data, the disclosed techniques reduce computational complexity and enable demand forecasts to be generated more efficiently. Additionally, by allocating CDN resources prior to launch based on the demand forecasts, the disclosed techniques reduce over-provisioning and under-provisioning of network bandwidth, server capacity, and edge node resources, improve geographic distribution of CDN resources, and reduce latency, buffering, and network congestion during presentation of prelaunch content items.

### System Overview

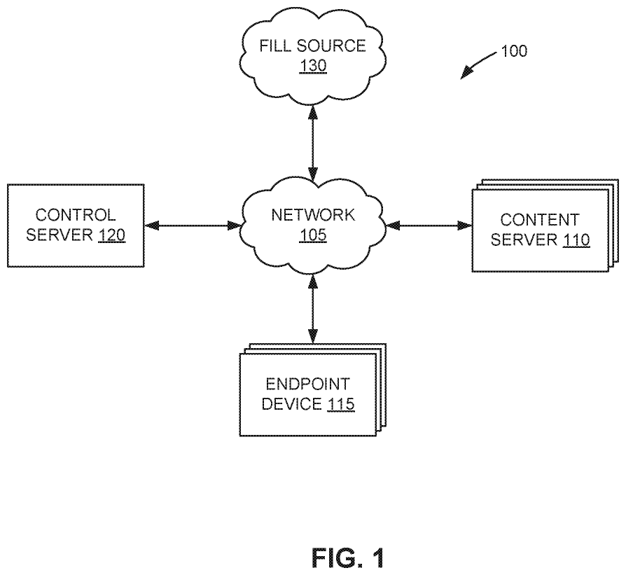

FIG. 1 illustrates a network infrastructure 100 used to distribute content to content servers 110 and endpoint devices 115, according to various embodiments of the invention. As shown, the network infrastructure 100 includes content servers 110, a control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computers, smartphones, tablets, consoles and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web server, a database, and a server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, the content servers 110 may respond to requests for files received from endpoint devices 115. The files may then be distributed from the content server 110 and/or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond the fill source 130 to the extent desired or necessary.

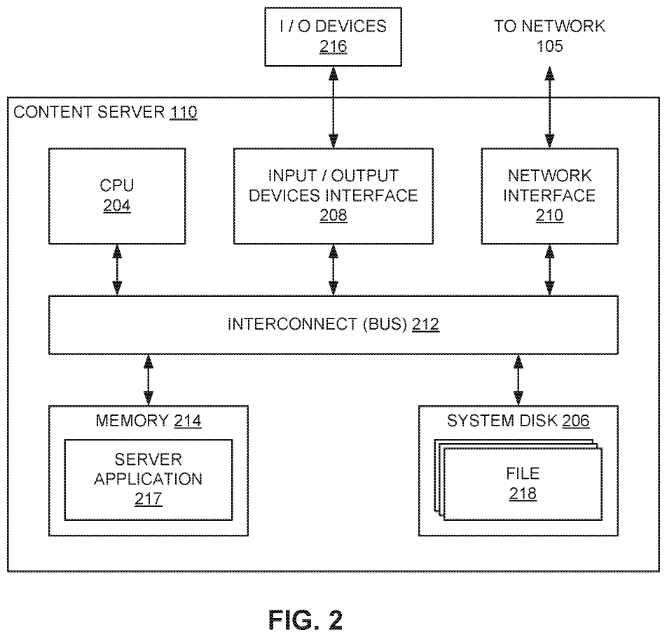

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, the I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint devices 115 and other content servers 110. When the server application 217 receives a request for a file 218, the server application 217 retrieves the corresponding file 218 from the system disk 206 and transmits the file 218 to an endpoint device 115 and/or a content server 110 via the network 105.

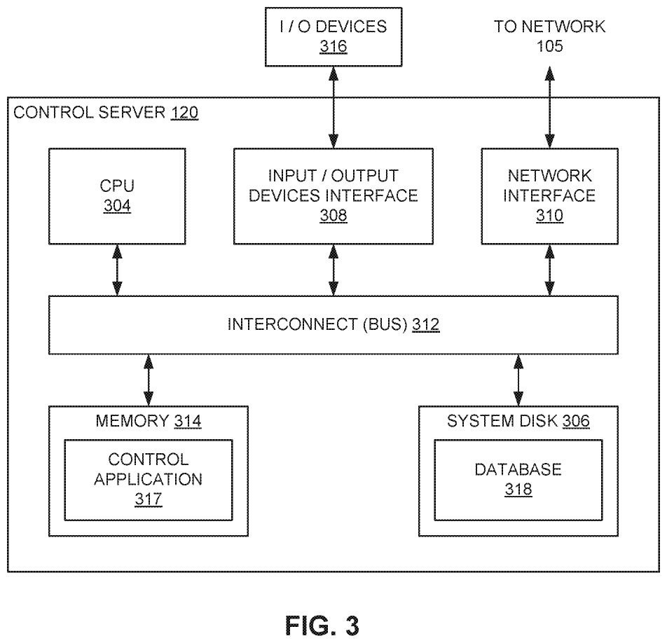

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, the I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

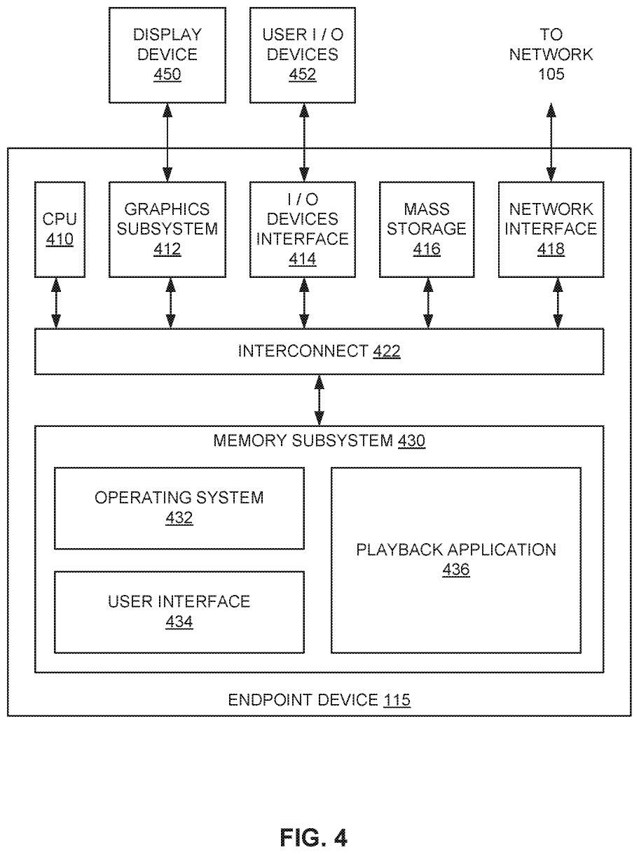

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, the graphics subsystem 412, the I/O devices interface 414, the mass storage unit 416, the network interface 418, and the memory subsystem 430.

In some embodiments, the graphics subsystem 412 is configured to generate frames of video data and transmit the frames of video data to display device 450. In some embodiments, the graphics subsystem 412 may be integrated into an integrated circuit along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. The input/output (I/O) device interface 414 is configured to receive input data from user I/O devices 452 and transmit the input data to the CPU 410 via the interconnect 422. For example, user 1/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

The mass storage unit 416, such as a hard disk drive or flash memory storage drive, is configured to store non-volatile data. The network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, the mass storage unit 416, the I/O device interface 414, and the graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well known in the art and suitable for incorporation into the endpoint device 115.

In some embodiments, the playback application 436 is configured to request and receive content from the content server 110 via the network interface 418. Further, the playback application 436 is configured to interpret the content and present the content via the display device 450 and/or the user I/O devices 452.

### Prelaunch Content Recommendation and Demand Forecasting

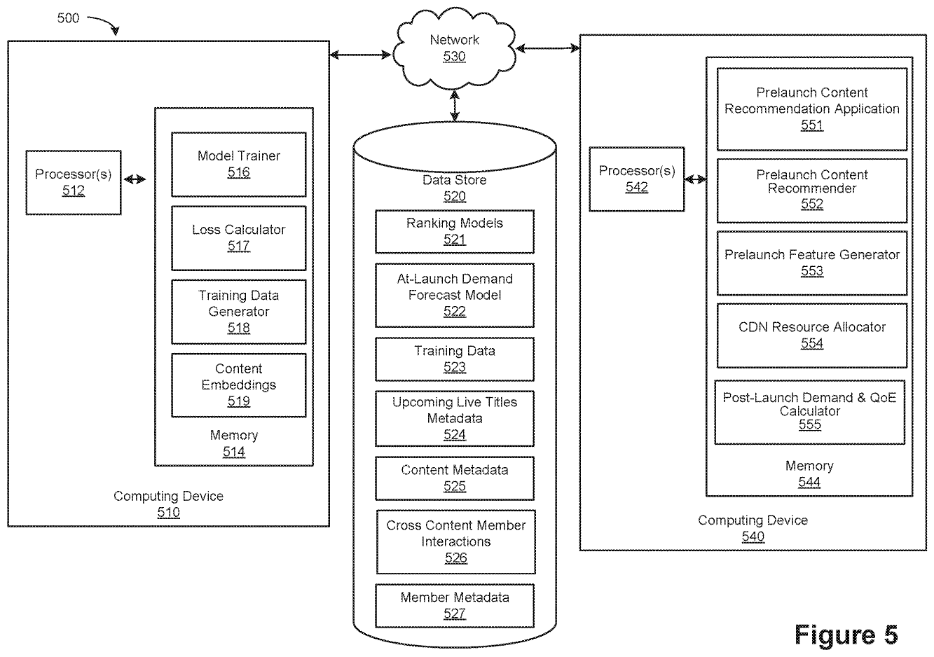

FIG. 5 is a block diagram of a computer-based system 500 according to various embodiments. As shown, computer-based system 500 includes, without limitation, computing devices 510 and 540, a data store 520, and a network 530. Computing device 510 includes, without limitation, one or more processors 512 and memory 514. Memory 514 includes, without limitation, a model trainer 516, a loss calculator 517, a training data generator 518, and one or more content embeddings 519. Data store 520 includes, without limitation, one or more ranking models 521, an at-launch demand forecast model 522, training data 523, upcoming live titles metadata 524, content metadata 525, cross content member interactions 526, and member metadata 527. Computing device 540 includes, without limitation, one or more processors 542 and memory 544. Memory 544 includes, without limitation, a prelaunch content recommendation application 551, a prelaunch content recommender 552, a prelaunch feature generator 553, a content delivery network (CDN) resource allocator 554, and a post-launch demand and quality of experience (QoE) metrics calculator 555. Although FIG. 5 is described in the context of content recommendation systems and demand forecasting systems, it is understood that the disclosed techniques are also applicable to other areas of content analysis and personalization, such as adaptive content delivery systems, targeted advertising platforms, dynamic user interface customization, and personalized educational content applications, and/or the like.

Computing device 510 shown herein is for illustrative purposes only, and variations and modifications in the design and arrangement of computing device 510 are within the scope of the present disclosure. For example, the number of processors 512, the number and/or type of memories 514, and/or the number of applications and/or data stored in memory 514 can be modified as desired. In some embodiments, any combination of processor(s) 512 and/or memory 514 can be included in and/or replaced with any type of virtual computing system, distributed computing system, and/or cloud computing environment, such as a public cloud system, private cloud system, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications. During operation, processor(s) 512 can receive user input from input devices (not shown), such as a keyboard or a mouse.

Memory 514 of computing device 510 stores content, such as software applications and data, for use by processor(s) 512. As shown, memory 514 includes, without limitation, engagement analysis module 515. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

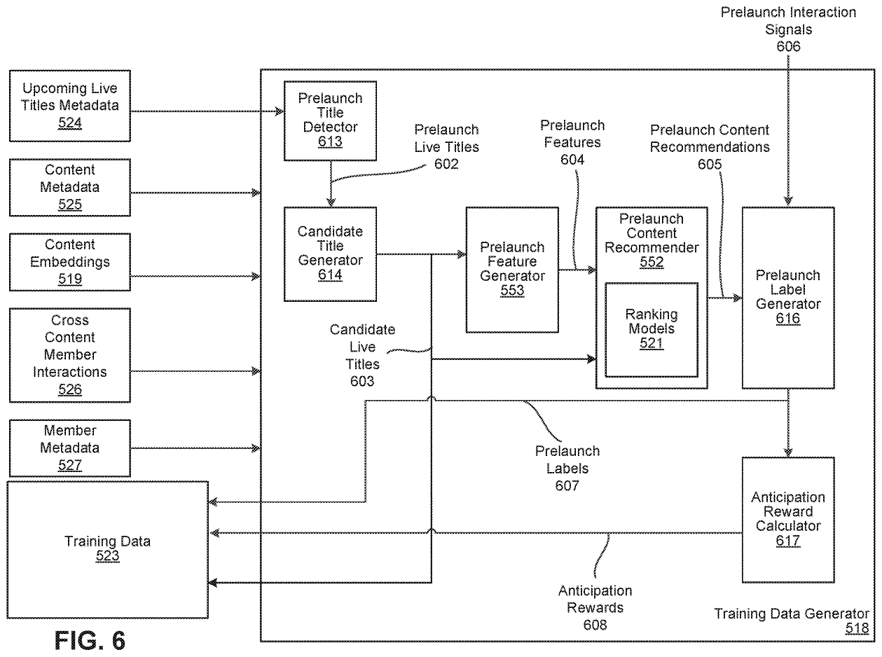

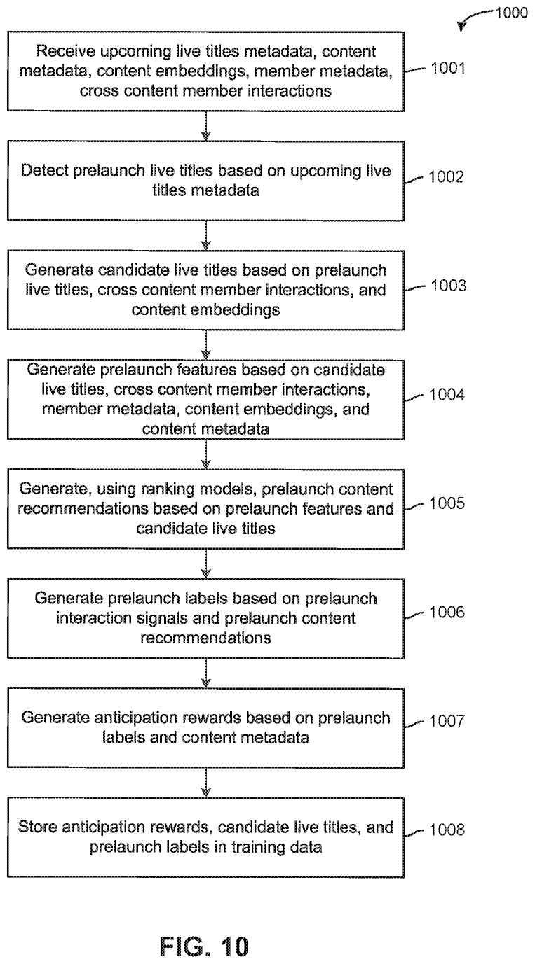

As shown, training data generator 518 is stored in memory 514 and is executed by processor(s) 512. In some embodiments, training data generator 518 is an application that processes upcoming live titles metadata 524, content metadata 525, content embeddings 519, member metadata 527, cross content member interactions 526, and member metadata 527, and generates training data 523. Upcoming live titles metadata 524 stored in data store 520 includes, without limitation, event identifiers, scheduled launch times, event durations, participant or talent information, content descriptors, such as titles, genres, and/or synopses, promotional assets including images and trailers, regional availability information, and any additional attributes associated with one or more upcoming live titles. Content metadata 525 stored in data store 520 includes, without limitation, content identifiers, titles, genres, categories, synopses, cast and crew information, release dates, duration, language and regional availability information, content ratings, and other descriptive attributes associated with one or more content items (e.g., a single, discrete unit of media, such as a specific movie, episode, or live event). Cross content member interactions 526 stored in data store 520 includes, without limitation, records of member interactions with content across various content types (e.g., a category of content items, such as movies, TV shows, or live events), including viewing history, playback events, clicks, search queries, impressions, browsing activity, additions to a watchlist or “my list,” reminder registrations, ratings or feedback signals, timestamps associated with such interactions, and contextual information describing how and when the interactions occurred, all of which could be used to model member preferences and engagement patterns. Member metadata 527 stored in data store 520 includes, without limitation, one or more attributes associated with a member (e.g., a viewer), such as historical interaction patterns, content preference profiles, viewing history, search history, watchlist additions, reminder registrations, device information, geographic location or region, language preferences, subscription tier, session activity patterns, and/or temporal engagement characteristics. Content embeddings 519 stored in memory 514 include, without limitation, one or more numerical representations of content items, such as dense vector embeddings or discrete feature sequences, generated, for example, using one or more machine learning models to capture semantic, visual, audio, and/or textual characteristics of the content items. In some embodiments, content metadata 525 and content embeddings 519 include attributes specific to live events, including timing, participants, and other characteristics that distinguish live content from on-demand content. Training data 523 stored in data store 520 includes, without limitation, one or more prelaunch labels, one or more candidate live titles, and one or more anticipation rewards. Training data generator 518 is described in greater detail herein at least in conjunction with FIGS. 6 and 10.

Loss calculator 517 is stored in memory 514 and is executed by processor(s) 512. In some embodiments, loss calculator 517 is an application that calculates a first loss based on one or more ranking scores, the prelaunch labels, and the anticipation rewards. In some embodiments, loss calculator 517 calculates a second loss based on an at-launch demand forecast and a post-launch demand and QoE metrics.

Model trainer 516 is an application that executes on one or more processors 512 of computing device 510 and is stored in memory 514 of computing device 510. Although shown as distinct from loss calculator 517 and training data generator 518 for illustrative purposes, in some embodiments, functionality of loss calculator 517, training data generator 518, and model trainer 516 can be combined into a single application or separated into any number of applications.

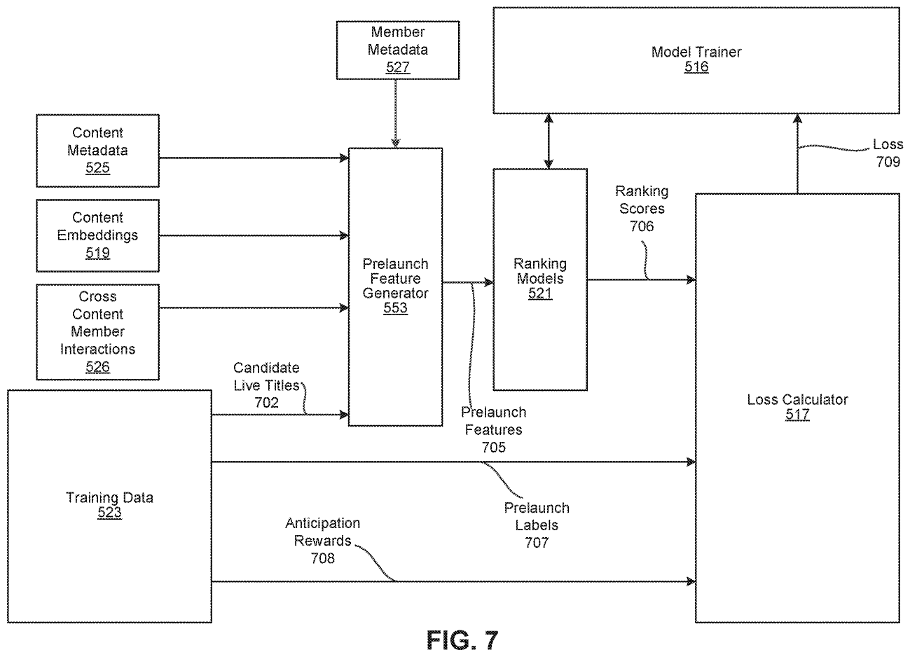

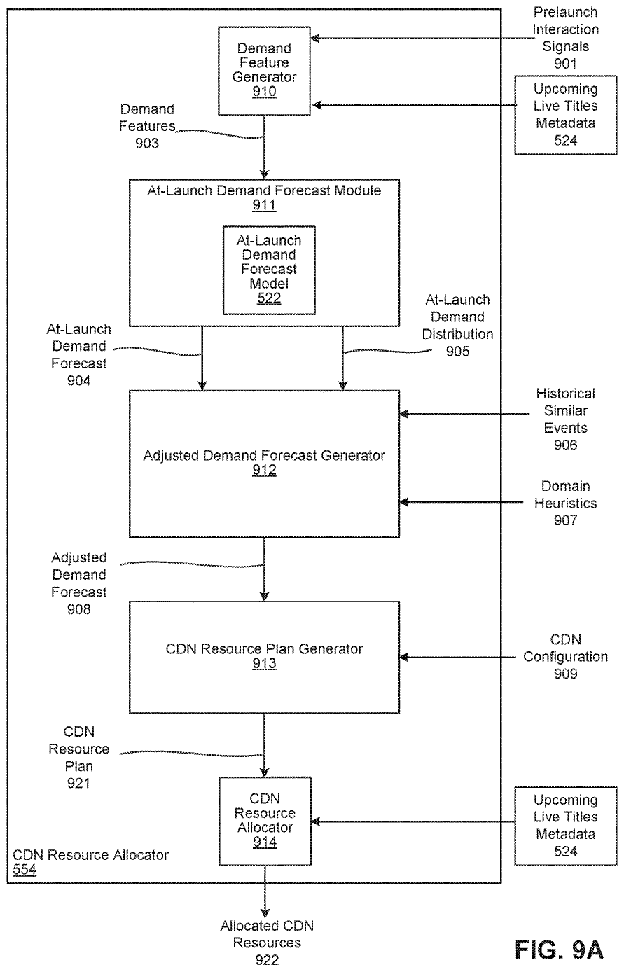

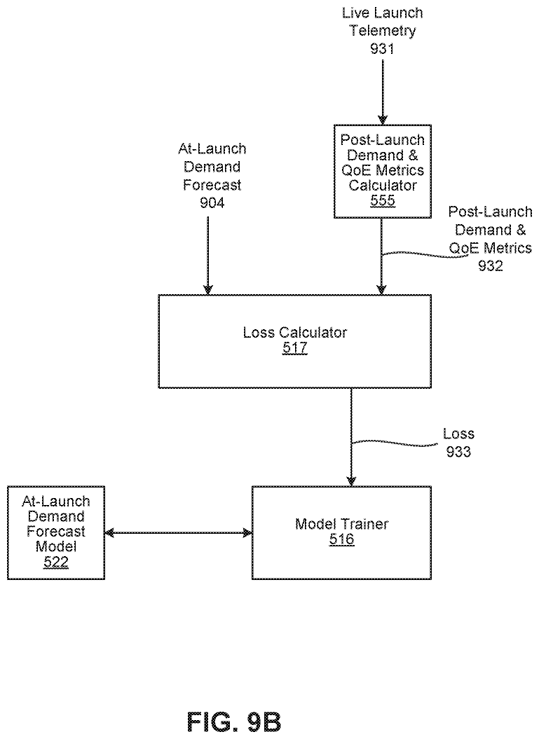

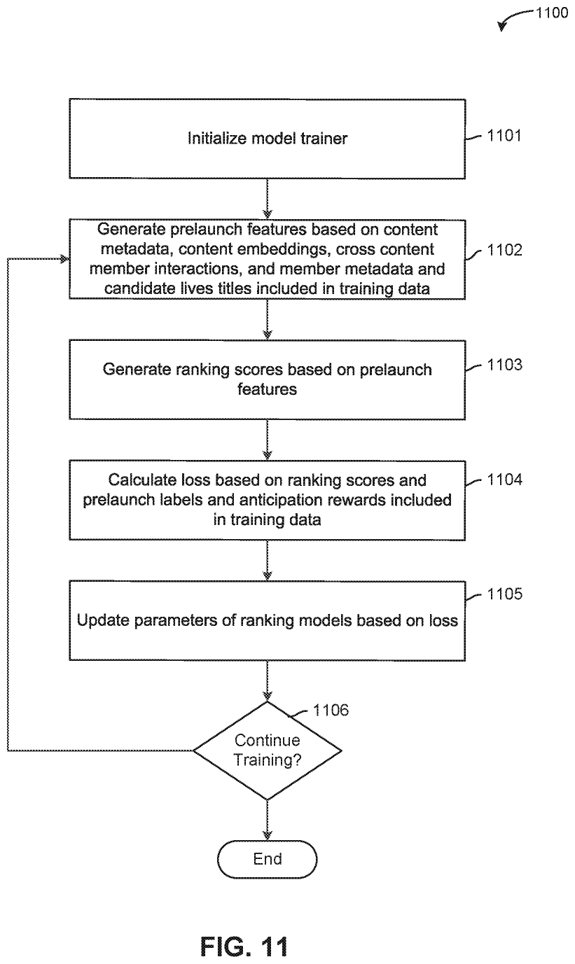

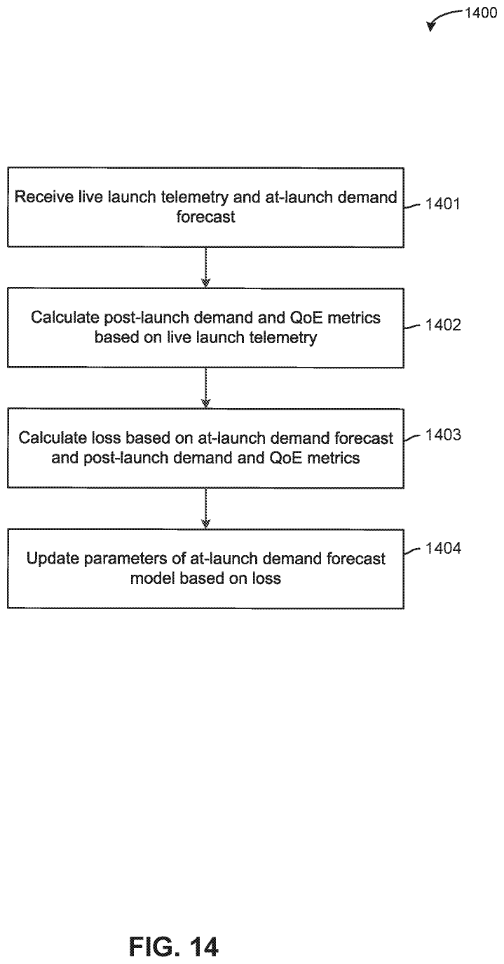

In some embodiments, model trainer 516 is configured to train one or more machine learning models, such as ranking models 521 and at-launch demand forecast model 522. Ranking models 521 stored in data store 520 or elsewhere (e.g., memory 514) are each a pretrained machine learning model, such as a neural network, which processes one or more prelaunch features and generates one or more ranking scores. At-launch demand forecast model 522 stored in data store 520 or elsewhere (e.g., memory 514) is a pretrained machine learning model, such as a neural network, which processes one or more demand features and generates an at-launch demand forecast. Techniques for training ranking models 521 based on training data 523, content metadata 525, content embeddings 519, and cross content member interactions 526 are described herein in greater detail at least in conjunction with FIGS. 7 and 11. Techniques for training at-launch demand forecast model 522 based on live launch telemetry and the at-launch demand forecast are described herein in greater detail at least in conjunction with FIGS. 9B and 14.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540 are within the scope of the present disclosure. For example, the number of processors 542, the number and/or type of memories 544, and/or the number of applications and/or data stored in memory 544 can be modified as desired. In some embodiments, any combination of processor(s) 542 and/or memory 544 can be included in and/or replaced with any type of virtual computing system, distributed computing system, and/or cloud computing environment, such as a public cloud system, private cloud system, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user input from input devices (not shown), such as a keyboard or a mouse.

Memory 544 of computing device 540 stores content, such as software applications and data, for use by processor(s) 542. As shown, memory 544 includes, without limitation, a recommendation application 546 and a cache 548. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

As shown, prelaunch feature generator 553 is stored in memory 544 and executes on processor(s) 542. In some embodiments, prelaunch feature generator 553 is an application that processes content metadata 525, the candidate live titles, content embeddings 519, cross content member interactions 526, and member metadata 527 and generates the prelaunch features.

Prelaunch content recommender 552 is stored in memory 544 and executes on processor(s) 542. In some embodiments, prelaunch content recommender 552 is an application that uses ranking models 521 to process one or more prelaunch features and one or more candidate live titles and generate one or more prelaunch content recommendations.

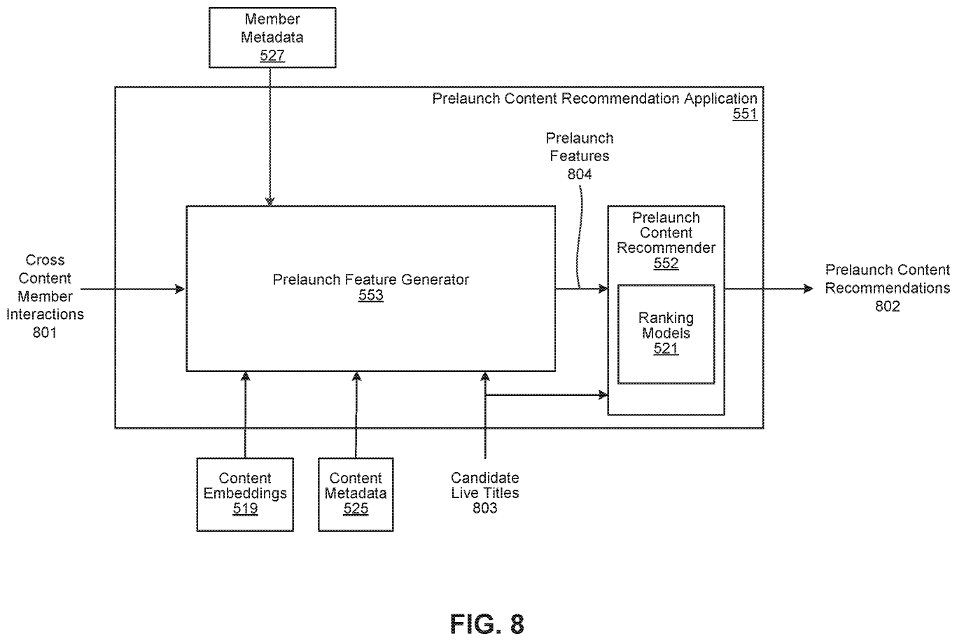

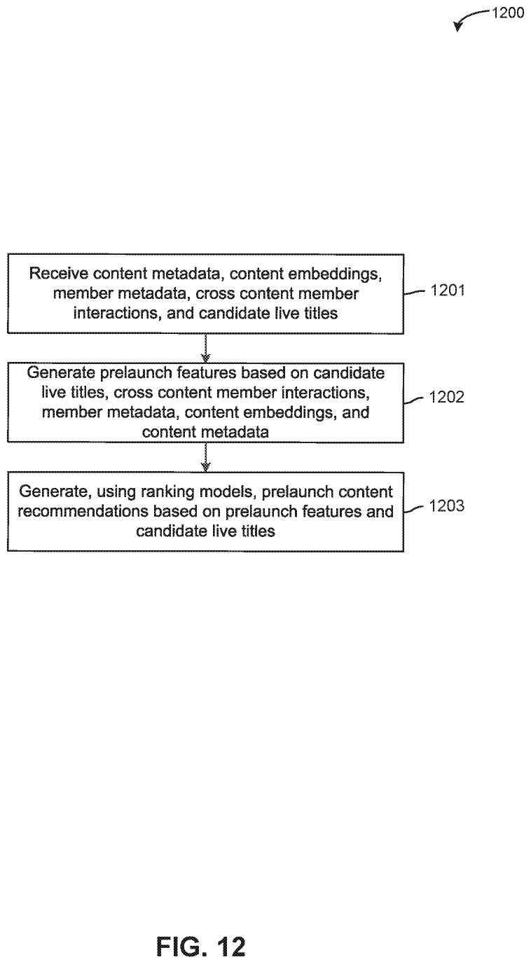

Prelaunch content recommendation application 551 is stored in memory 544 and executes on processor(s) 542. In some embodiments, prelaunch content recommendation application 551 uses prelaunch feature generator 553 and prelaunch content recommender 552 to process cross content member interactions 526, the candidate live titles, content embeddings 519, and content metadata 525 and generate the prelaunch content recommendations. Prelaunch content recommendation application 551 is described in greater detail herein at least in conjunction with FIGS. 8 and 12.

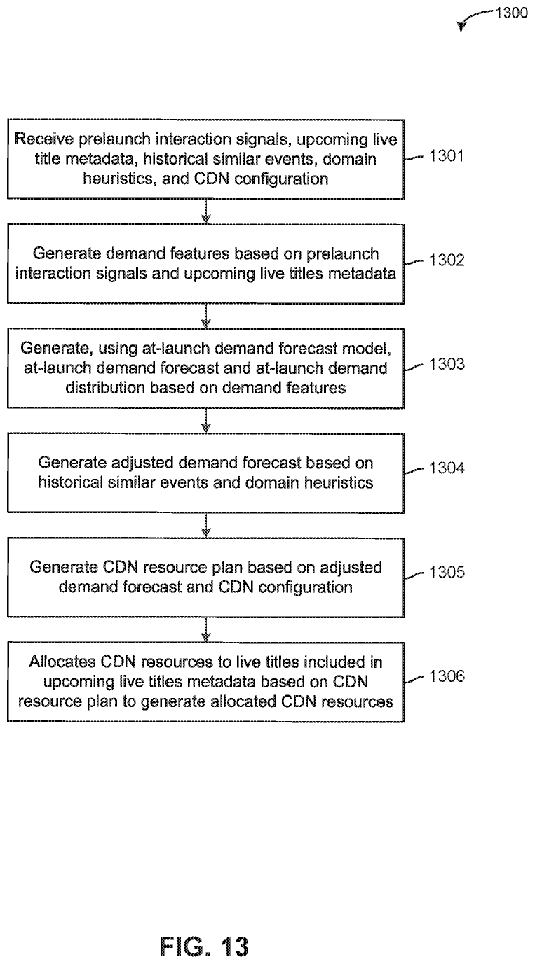

CDN resource allocator 554 is stored in memory 544 and executes on processor(s) 542. In some embodiments, CDN resource allocator 554 is an application that processes one or more prelaunch interaction signals and upcoming live titles metadata 524 and generates one or more allocated CDN resources. CDN resource allocator 554 is described in greater detail herein at least in conjunction with FIGS. 9A and 13.

Post-Launch demand and QoE metrics calculator 555 is stored in memory 544 and executes on processor(s) 542. In some embodiments, post-Launch demand and QoE metrics calculator 555 is an application that calculates post-launch demand and QoE metrics based on live launch telemetry.

### Generating Prelaunch Labels and Anticipation Awards

FIG. 6 is a more detailed illustration of training data generator 518, according to various embodiments. As shown, training data generator 518 includes, without limitation, prelaunch title detector 613, candidate title generator 614, prelaunch feature generator 553, prelaunch content recommender 552, prelaunch label generator 616, and anticipation reward calculator 617. Prelaunch content recommender 552 includes, without limitation, ranking models 521. In operation, prelaunch title detector 613 detects prelaunch live titles 602 based on upcoming live titles metadata 524. Candidate title generator 614 processes prelaunch live titles 602, cross content member interactions 526, and content embeddings 519 and generates candidate live titles 603. Prelaunch feature generator 553 processes candidate live titles 603, cross content member interactions 526, content embeddings 519, content metadata 525, and member metadata 527 and generates prelaunch features 604. Prelaunch content recommender 552 uses ranking models 521 to process prelaunch features 604 and candidate live titles 603 and generate prelaunch content recommendations 605. Prelaunch label generator 616 processes prelaunch content recommendations 605 and prelaunch interaction signals 606 and generates prelaunch labels 607. Anticipation reward calculator 617 processes prelaunch labels 607 and content metadata 525 and generates anticipation rewards 608. Training data generator 518 stores candidate live titles 603, prelaunch labels 607, and anticipation rewards 608 in training data 523.

Prelaunch title detector 613 is a module of training data generator 518 that detects prelaunch live titles 602 based on upcoming live titles metadata 524. In some embodiments, prelaunch title detector 613 detects prelaunch live titles 602 based on upcoming live titles metadata 524 by identifying content items having a launch time later than a current time. In some embodiments, upcoming live titles metadata 524 includes, for each content item i, a corresponding launch time Tᵢ, and prelaunch title detector 613 compares Tᵢ to a current time t to determine whether the content item is a prelaunch live title 602. For example, prelaunch title detector 613 can generate a set of prelaunch live titles 602 according to L^{pre}={i|Tᵢ>t}, where L^{pre} denotes the set of detected prelaunch live titles 602. In some embodiments, prelaunch title detector 613 further filters or updates the set of prelaunch live titles 602 based on additional metadata attributes, such as regional availability or scheduling updates.

Candidate title generator 614 is a module of training data generator 518 that processes prelaunch live titles 602, cross content member interactions 526, and content embeddings 519 and generates candidate live titles 603. In some embodiments, candidate title generator 614 retrieves, for a given member u, a subset of prelaunch live titles 602 that are likely to be relevant to the member based on historical interaction patterns and similarity between content items. For example, let Iᵤ denote cross content member interactions 526 associated with member u. Candidate title generator 614 can generate a candidate live titles 603 set Cᵤ according to Cᵤ=Retrieve(u,L^{Pre},Iᵤ,E), where E={Eᵢ} denotes content embeddings 519 associated with prelaunch live titles 602. In some embodiments, the retrieval operation uses one or more similarity computations between content embeddings 519, such as sim(i,j)= [symbol] Eᵢ,Eⱼ [symbol] , where [symbol] .,. [symbol] denotes inner product, to identify prelaunch live titles 602 i that are similar to content items j previously interacted with by the member. For example, for a given member u having a set of previously interacted content items Iᵤ, candidate title generator 614 can compute an aggregated similarity score for each prelaunch live title 602 i according to S_{u,i}=Σ_{j∈I}_{ᵤ} w_{u,j}· [symbol] Eᵢ,Eⱼ [symbol] , where w_{u,j} represents a weight associated with an interaction of the member u with content item j. In some embodiments, candidate live titles 603 are selected based on the aggregated similarity scores, such as by selecting a subset of prelaunch live titles 602 having the highest values of S_{u,i}.

Prelaunch feature generator 553 processes candidate live titles 603, cross content member interactions 526, content embeddings 519, content metadata 525, and member metadata 527 and generates prelaunch features 604. In some embodiments, for a given member u and a candidate live title 603 i, prelaunch feature generator 553 constructs a feature vector that encodes relationships between the member and candidate live title 603 based on historical interactions, content representations, and metadata attributes. In some embodiments, candidate live title 603 corresponds to a live event that is not yet available for playback, and prelaunch features 604 are generated based on member interactions with preview experiences associated with candidate live title 603 prior to a launch time. For example, prelaunch features 604 can be generated according to:

x_{u,i}=φ(Iᵤ,mᵤ,Eᵢ,Mᵢ), (Equation 1)

where Iᵤ denotes cross content member interactions 526 associated with member u, Eᵢ denotes a content embedding 519 associated with candidate live title 603 i, mᵤ denotes member metadata 527 associated with member u, and Mᵢ denotes content metadata 525 associated with candidate live title 603 i. In some embodiments, the feature vector x_{u,i} included in prelaunch features 604 further includes similarity-based features derived from content embeddings 519, interaction-based features derived from cross content member interactions 526 Iᵤ, and metadata-based features derived from content embeddings 519 Mᵢ.

Prelaunch content recommender 552 uses ranking models 521 to process prelaunch features 604 and candidate live titles 603 and generate prelaunch content recommendations 605. In some embodiments, ranking models 521 process prelaunch features 604 and generate one or more ranking scores. In some embodiments, ranking models 521 include, without limitation, a row ranking model and a title ranking model. In some embodiments, for a given member u and a candidate live title 603 i, ranking models 521 process prelaunch features 604 to generate the ranking scores according to:

$${s}_{u , i}^{title} = {f}_{{θ}_{t}} ( {x}_{u , i} ) and {s}_{u , i}^{row} = {f}_{{θ}_{r}} ( {x}_{u , i} ) , \qquad ( Equation 2 )$$

where x_{u,i} denotes prelaunch features 604, ƒ_{θ}_{ₜ} denotes a title ranking model, and ƒ_{θ}_{ᵣ} denotes a row ranking model. In some embodiments, the title ranking model ƒ_{θ}_{ₜ}, generates the ranking scores representing a predicted likelihood that the member will engage with a candidate live title 603, while the row ranking model ƒ_{θ}_{ᵣ} generates the ranking scores representing a relevance of a content row or grouping associated with candidate live titles 603. In some embodiments, the resulting ranking scores are combined to generate a final ranking score according to:

$${s}_{u , i} = Ψ ( {s}_{u , i}^{title} , {s}_{u , i}^{row} ) , \qquad ( Equation 3 )$$

where Ψ(⋅) denotes a combination function that can include, without limitation, a weighted combination, a learned function, or a rule-based aggregation. In some embodiments, prelaunch content recommender 552 ranks candidate live titles 603 for the member u based on the final ranking scores s_{u,i}, such that:

$${π}_{u} = Rank ( {C}_{u} , {\{ {s}_{u , i} \}}_{i ∈ {C}_{u}} ) , \qquad ( Equation 4 )$$

where πᵤ denotes an ordered list of ranked prelaunch content recommendations 605. In some embodiments, prelaunch content recommendations 605 are generated by selecting a subset of the ranked candidate live titles 603, such as top-K titles Rᵤ=TopK(πᵤ), where Rᵤ denotes prelaunch content recommendations 605. In some embodiments, prelaunch content recommender 552 further applies exploration strategies to adjust the ranking scores to generate adjusted ranking scores. Adjusting the ranking scores can include modifying scores or selection probabilities for one or more candidate live titles 603 based on exploration parameters, such as uncertainty, recency, or timeliness associated with the candidate live titles 603. For example, a modified score can be computed according to:

s\tilde{ }_{u,i}=s_{u,i}+β·ϵ_{u,i}, (Equation 5)

where ϵ_{u,i} denotes an exploration term and β controls a degree of exploration. In some embodiments, the exploration term is determined based on a bandit algorithm, such as an upper confidence bound (UCB), Boltzmann, or Thompson sampling approach, such that candidate live titles 603 with higher uncertainty or limited prior interaction data are more likely to be explored. In some embodiments, the bandit algorithm updates selection parameters based on observed prelaunch interaction signals 606 from the member, such that probabilities of selecting candidate live titles 603 are adjusted over time in response to member interactions. In some embodiments, prelaunch content recommendations 605 are selected based on the modified scores or probabilities and are provided for presentation to the member via a user interface, such as a homepage or recommendation surface, prior to candidate live titles 603 becoming playable.

Prelaunch label generator 616 is a module of training data generator 518 that processes prelaunch content recommendations 605 and prelaunch interaction signals 606 and generates prelaunch labels 607. Prelaunch interaction signals 606 received from one or more I/O devices, such as client devices including mobile devices, smart televisions, set-top boxes, personal computers, tablets, and/or web browsers, include, without limitation, user interactions with prelaunch content recommendations 605, such as clicks, selections, navigation events, additions to a watchlist or “my list,” reminder registrations, search queries, and associated timestamps indicating when such interactions occurred. In some embodiments, for a given member u and a recommended candidate live title 603 i, prelaunch label generator 616 identifies prelaunch interaction signals 606 associated with the presentation of the recommended candidate live title 603 and aggregates such signals over a prelaunch time window. For example, let

$${S}_{u , i} = {\{ ( {c}_{u , i , j} , {τ}_{u , i , j} ) \}}_{j = 1}^{{N}_{u , i}}$$

denote the set of prelaunch interaction signals 606 for member u and recommended candidate live title 603 i included in prelaunch content recommendations 605, where c_{u,i,j} denotes a signal type (e.g., click, reminder registration, watchlist addition, impression, and/or the like) and τ_{u,i,j} denotes a corresponding timestamp. Prelaunch label generator 616 can generate a prelaunch label 607 according to:

y_{u,i}=g(S_{u,i}), (Equation 6)

where g(⋅) aggregates prelaunch interaction signals 606. In some embodiments, the mapping function g(⋅) assigns weights to different interaction types to generate weighted interaction types and aggregates the weighted the interaction types to generate a scalar prelaunch label 607, such as

$${y}_{u , i} = {\sum }_{j = 1}^{{N}_{u , i}} w ( {c}_{u , i , j} ) , \qquad ( Equation 7 )$$

where w(⋅) assigns higher weights to stronger engagement signals included in prelaunch interaction signals 606. In some embodiments, prelaunch label generator 616 further incorporates the timestamps included in prelaunch interaction signals 606. For example, interactions occurring closer to a launch time Tᵢ of a recommended candidate live title 603 can be assigned greater influence, such as:

$${y}_{u , i} = {\sum }_{j = 1}^{{N}_{u , i}} w ( {c}_{u , i , j} ) \cdot γ ( {T}_{i} - {τ}_{u , i , j} ) , \qquad ( Equation 8 )$$

where γ(⋅) is a temporal weighting function that increases as the interaction time approaches the launch time. In some embodiments, prelaunch label generator 616 generates different label types, including binary labels, multi-level labels, or continuous-valued labels, depending on the aggregation strategy. For example, a binary prelaunch label 607 can be generated according to:

y_{u,i}={1, if at least one qualifying interaction is detected 0, otherwise (Equation 9)

while a continuous prelaunch label 607 can represent an intensity of engagement based on aggregated prelaunch interaction signals 606. In some embodiments, prelaunch label generator 616 assigns prelaunch label 607 values based on a type of prelaunch interaction signals 606, such as assigning a higher label value for a reminder registration or a “my list” addition relative to a click or impression. For example, prelaunch label generator 616 can assign prelaunch label 607 values according to:

y_{u,i}={y_{remind}, if a reminder registration is detected yₗᵢₛₜ, if a watchlist addition is detected y_{click}, if a click is detected yᵢₘₚ, otherwise}, (Equation 10)

where y_{remind}>yₗᵢₛₜ>y_{click}>yᵢₘₚ.

Anticipation reward calculator 617 is a module of training data generator 518 that processes prelaunch labels 607 and content metadata 525 and generates anticipation rewards 608. In some embodiments, for a given member u and a recommended candidate live title 603 i, anticipation reward calculator 617 determines a reward value based on a timing of an interaction relative to a launch time of the recommended candidate live title 603. For example, content metadata 525 includes a launch time Tᵢ associated with the recommended candidate live title 603 i, and each prelaunch label 607 y_{u,i} is associated with one or more interaction timestamps T_{u,i,j}. Anticipation reward calculator 617 computes a temporal distance, such as according to:

Δ_{u,i,j}=Tᵢ−τ_{u,i,j}. (Equation 11)

In some embodiments, anticipation reward calculator 617 applies a reward function that varies based on the temporal distance to generate a reward value r_{u,i,j}=ƒᵢ(Δ_{u,i,j}), where ƒᵢ(⋅) is a time-dependent reward function associated with candidate live title 603 i. In some embodiments, the reward function increases as the interaction time approaches the launch time, reaches a peak value at or near the launch time, and decreases after the launch time. In some embodiments, different candidate live titles 603 are associated with different reward functions ƒᵢ(⋅) based on content attributes included in content metadata 525, such that content items having higher time sensitivity are associated with reward functions that exhibit sharper peaks around the launch time. In some embodiments, anticipation reward calculator 617 aggregates reward values across multiple interaction signals associated with the same member and recommended candidate live titles 603 to generate a final anticipation reward 608, such as

$${r}_{u , i} = {\sum }_{j = 1}^{{N}_{u , i}} {r}_{u , i , j} , \qquad ( Equation 12 )$$

or, in some embodiments,

$${r}_{u , i} = {max}_{j} {r}_{u , i , j} , \qquad ( Equation 13 )$$

In some embodiments, anticipation reward calculator 617 further adjusts the reward based on attributes of the recommended candidate live title 603 included in content metadata 525, such as a type of live event, duration, and/or timeliness characteristics, such that different categories of content can be associated with different reward scaling behaviors. In some embodiments, anticipation rewards 608 are normalized relative to a baseline value. In some embodiments, anticipation rewards 608 reflect a contribution of prelaunch interactions to long-term member satisfaction, such that interactions indicating higher anticipation for a live event are assigned greater influence during training of ranking models 521.

### Training Ranking Models Using Training Data

FIG. 7 is a more detailed illustration of model trainer 516 training ranking models 521, according to various embodiments. In operation, prelaunch feature generator 553 processes content metadata 525, content embeddings 519, cross content member interactions 526, member metadata 527, and candidate live titles 702 included in training data 523 and generates prelaunch features 705. Ranking models 521 process prelaunch features 705 and generate ranking scores 706. Loss calculator 517 calculates loss 709 based on ranking scores 706 and prelaunch labels 707 and anticipation rewards 708 included in training data 523. Model trainer 516 uses loss 709 to iteratively update one or more parameters of ranking models 521 until one or more stopping criteria are met.

Prelaunch feature generator 553 processes candidate live titles 702 included in training data 523, cross content member interactions 526, member metadata 527, content embeddings 519, and content metadata 525, and generates prelaunch features 705. In some embodiments, for a given member u and a candidate live title 702 i, prelaunch feature generator 553 constructs a feature vector that encodes relationships between the member and candidate live title 702 based on historical interactions, content representations, and metadata attributes. For example, prelaunch features 705 can be generated according to Equation 1. In some embodiments, the feature vector x_{u,i} included in prelaunch features 705 further includes similarity-based features derived from content embeddings 519, interaction-based features derived from cross content member interactions 526 Iᵤ, and metadata-based features derived from content metadata 525 Mᵢ.

Ranking models 521 process prelaunch features 705 and generate ranking scores 706. In some embodiments, ranking models 521 include, without limitation, a row ranking model and a title ranking model. In some embodiments, for a given member u and a candidate live title 702 i, ranking models 521 process prelaunch features 705 to generate ranking scores 706 according to Equation 2. In some embodiments, the title ranking model ƒ_{θ}_{ₜ} generates ranking scores 706 representing a predicted likelihood that the member will engage with a candidate live title 702, while the row ranking model ƒ_{θ}_{ᵣ} generates ranking scores 706 representing a relevance of a content row or grouping associated with candidate live titles 702. In some embodiments, the resulting ranking scores 706 are combined to generate a final ranking score 706 according to Equation 3.

Loss calculator 517 calculates loss 709 based on ranking scores 706 and prelaunch labels 707 and anticipation rewards 708 included in training data 523. In some embodiments, loss calculator 517 computes a loss between the generated ranking scores 706 and corresponding prelaunch labels 707, for example:

$${L}_{u , i}^{title} = l ( {y}_{u , i}^{\hat{} title} , {y}_{u , i} ) , {L}_{u , i}^{row} = l ( {y}_{u , i}^{\hat{} row} , {y}_{u , i} ) , \qquad ( Equation 14 )$$

where y_{u,i} denotes a prelaunch label 707 associated with member u and candidate live title 702 i, and l(⋅,⋅) denotes a loss function, such as a logistic loss, cross-entropy loss, or mean squared error. L_{u,l}^{title} is the loss associated with the title ranking model included in ranking models 521 and L_{u,i}^{title} is the loss associated with the row ranking model included in ranking models 521. In some embodiments, anticipation rewards 708 are applied as multiplicative data weights to adjust contributions of different training examples. For example, weighted losses can be computed according to:

$${L}_{u , i}^{∼ title} = {r}_{u , i} \cdot {L}_{u , i}^{title} , {L}_{u , i}^{∼ row} = {r}_{u , i} \cdot {L}_{u , i}^{row} , \qquad ( Equation 15 )$$

In some embodiments, anticipation rewards r_{u,i} are normalized relative to a baseline value, such that values greater than the baseline increase an influence of a corresponding training example and values less than the baseline decrease the influence of the corresponding training example. In some embodiments, training examples associated with interactions occurring closer to a launch time receive higher weights, thereby increasing the influence during model training. In some embodiments, loss calculator 517 aggregates weighted losses across members and candidate live titles 702 to generate loss 709, for example:

$${J}_{title} = {\sum }_{( u , i )} {L}_{u , i}^{∼ title} , {J}_{row} = {\sum }_{( u , i )} {L}_{u , i}^{∼ row} . \qquad ( Equation 16 )$$

In some embodiments, weighting of training examples using anticipation rewards 708 aligns optimization of ranking models 521 with long-term member satisfaction objectives by prioritizing recommendations that drive meaningful prelaunch engagement for live events.

In some embodiments, model trainer 516 uses loss 709 to iteratively update one or more parameters of ranking models 521 until one or more stopping criteria are met. In some embodiments, for a given ranking model 521 parameterized by θ, model trainer 516 updates the parameters based on loss 709 according to:

θ←θ−η∇_{θ}J(θ), (Equation 17)

where η denotes a learning rate, ∇_{θ}J(θ) denotes a gradient of loss 709. In some embodiments, separate parameter updates are performed for different ranking models 521, such as the title ranking model and the row ranking model, for example, according to:

θₜ←θₜ−ηₜ∇_{θ}_{ₜ}Jₜᵢₜₗₑ(θₜ),θᵣ←θᵣ−ηᵣ∇_{θ}_{ᵣ}J_{row}(θᵣ), (Equation 18)

where θₜ and θᵣ denote parameters of the title ranking model and the row ranking model, respectively. ηₜ and ηᵣ denote the learning rates associated with the title ranking model and the row ranking model, respectively. In some embodiments, model trainer 516 performs updates using mini-batches of training data 523, such that gradients are computed over subsets of training examples to improve computational efficiency. In some embodiments, one or more optimization techniques are applied, including stochastic gradient descent, adaptive optimization methods, or regularization techniques, to improve convergence and generalization. In some embodiments, the one or more stopping criteria include reaching a threshold number of training iterations, convergence of loss 709, stabilization of validation performance, or satisfaction of a predefined performance metric. Upon satisfying the one or more stopping criteria, model trainer 516 stores ranking models 521 in data store 520 or elsewhere.

### Prelaunch Content Recommendation Using Trained Ranking Models

FIG. 8 is a more detailed illustration of prelaunch content recommendation application 551, according to various embodiments. As shown, prelaunch content recommendation application 551 includes, without limitation, prelaunch feature generator 553 and prelaunch content recommender 552. Prelaunch content recommender 552 includes ranking models 521. In operation, prelaunch feature generator 553 processes cross content member interactions 801, candidate live titles 803, content embeddings 519, member metadata 527, and content metadata 525 and generates prelaunch features 804. Prelaunch content recommender 552 uses ranking models 521 to process prelaunch features 804 and generate prelaunch content recommendations 802.

Prelaunch feature generator 553 processes candidate live titles 803, cross content member interactions 801, content embeddings 519, member metadata 527, and content metadata 525 and generates prelaunch features 804. In some embodiments, cross content member interactions 801 are received from one or more I/O devices, such as client devices including mobile devices, smart televisions, set-top boxes, personal computers, tablets, and/or web browsers, and include, without limitation, records of member interactions with content items across multiple content types, such as viewing history, playback events, clicks, search queries, impressions, browsing activity, additions to a watchlist or “my list,” reminder registrations, ratings or feedback signals, and timestamps associated with such interactions. Candidate live titles 803 include, without limitation, a subset of content items corresponding to upcoming live titles selected for evaluation for a given member, where such content items are associated with respective content identifiers, launch times, content embeddings 519, and content metadata 525. In some embodiments, for a given member u and a candidate live title 803 i, prelaunch feature generator 553 constructs a feature vector that encodes relationships between the member and candidate live title 803 based on historical interactions, content representations, and metadata attributes. For example, prelaunch features 804 can be generated according to Equation 1. In some embodiments, the feature vector x_{u,i} included in prelaunch features 804 further includes similarity-based features derived from content embeddings 519, interaction-based features derived from cross content member interactions 801 Iᵤ, and metadata-based features derived from content metadata 525 Mᵢ.

Prelaunch content recommender 552 uses ranking models 521 to process prelaunch features 804 and candidate live titles 803 and generate prelaunch content recommendations 802. In some embodiments, ranking models 521 process prelaunch features 804 and generate one or more ranking scores. In some embodiments, ranking models 521 include a row ranking model and a title ranking model. In some embodiments, for a given member u and a candidate live title 803 i, ranking models 521 process prelaunch features 804 to generate the ranking scores according to Equation 2. In some embodiments, the title ranking model ƒ_{θ}_{ₜ} generates the ranking scores representing a predicted likelihood that the member will engage with a candidate live title 803, while the row ranking model ƒ_{θ}_{ᵣ} generates the ranking scores representing a relevance of a content row or grouping associated with candidate live titles 803. In some embodiments, the resulting ranking scores are combined to generate a final ranking score according to Equation 3. In some embodiments, prelaunch content recommender 552 ranks candidate live titles 803 for the member u based on the final ranking scores s_{u,i}, such that Equation 4 is satisfied. In some embodiments, prelaunch content recommendations 802 are generated by selecting a subset of the ranked candidate live titles 803, such as top-K titles Rᵤ=TopK(πᵤ), where Rᵤ denotes prelaunch content recommendations 802. In some embodiments, prelaunch content recommender 552 further applies exploration strategies to adjust the ranking scores to generate adjusted ranking scores, including modifying scores or selection probabilities for one or more candidate live titles 803 based on exploration parameters, such as uncertainty, recency, or timeliness associated with candidate live titles 803. For example, a modified score can be computed according to Equation 5. In some embodiments, the exploration term is determined based on a bandit algorithm, such as a UCB, Boltzmann, or Thompson sampling approach, such that candidate live titles 803 with higher uncertainty or limited prior interaction data are more likely to be explored. In some embodiments, the bandit algorithm updates selection parameters based on observed prelaunch interaction signals from the member, such that probabilities of selecting candidate live titles 803 are adjusted over time in response to member interactions. In some embodiments, prelaunch content recommendations 802 are selected based on the modified scores or probabilities and are provided for presentation to the member via a user interface, such as a homepage or recommendation surface, prior to candidate live titles 803 becoming playable.

### Allocating CDN Resources Based on Prelaunch Interaction Signals and Upcoming Live Titles Metadata

FIG. 9A is a more detailed illustration of content delivery network (CDN) resource allocator 554, according to various embodiments. As shown, CDN resource allocator 554 includes, without limitation, a demand feature generator 910, an at-launch demand forecast module 911, an adjusted demand forecast generator 912, a CDN resource plan generator 913, and a CDN resource allocator 914. In operation, demand feature generator 910 processes prelaunch interaction signals 901 and upcoming live titles metadata 524 and generates one or more demand features 903. At-launch demand forecast module 911 uses at-launch demand forecast model 522 to process demand features 903 and generate an at-launch demand forecast 904 and an at-launch demand distribution 905. Adjusted demand forecast generator 912 processes one or more historical similar events 906 and one or more domain heuristics 907 and generates an adjusted demand forecast 908. CDN resource plan generator 913 processes adjusted demand forecast 908 and a CDN configuration 909 and generates a CDN resource plan 921. CDN resource allocator 914 allocates CDN resources to live titles included in upcoming live titles metadata 524 based on CDN resource plan 921 to generate allocated CDN resources 922.

Demand feature generator 910 is a module of CDN resource allocator 554 that processes prelaunch interaction signals 901 and upcoming live titles metadata 524 and generates demand features 903. In some embodiments, for a given live title i included in upcoming live titles metadata 524, demand feature generator 910 aggregates prelaunch interaction signals 901 associated with the live title i and combines such signals with metadata attributes to construct a feature vector usable for demand estimation. For example, let

$${S}_{i} = {\{ ( {c}_{i , j} , {τ}_{i , j} ) \}}_{j = 1}^{{N}_{i}}$$

denote prelaunch interaction signals 901 associated with candidate live title i, where c_{i,j} denotes a type of interaction signal and τ_{i,j} denotes a corresponding timestamp. In some embodiments, demand feature generator 910 computes temporal distances relative to a launch time Tᵢ included in upcoming live titles metadata 524, for example, according to Equation 11. In some examples, demand features 903 are generated according to xᵢ=φ(Sᵢ,Mᵢ), where Mᵢ denotes metadata associated with the live title i. In some embodiments, the feature vector xᵢ includes aggregated interaction counts, such as counts of reminder registrations, clicks, and watchlist additions, as well as time-weighted interaction signals based on Δ_{i,j}, and metadata-based features derived from Mᵢ. In some embodiments, watchlist additions (e.g., “my-list” interactions) are assigned greater importance relative to other interaction types as leading indicators of demand. For example:

$${x}_{i} = [ {\sum }_{j = 1}^{{N}_{i}} w ( {c}_{i , j} ) f ( {Δ}_{i , j} ) , {\sum }_{j = 1}^{{N}_{i}} 1 [ {c}_{i , j} = remind - me ] , {\sum }_{j = 1}^{{N}_{i}} 1 [ {c}_{i , j} = click ] , {\sum }_{j = 1}^{{N}_{i}} 1 [ {c}_{i , j} = my - list ] , {M}_{i} ] . \qquad ( Equation 19 )$$

where the function ƒ(⋅) denotes a temporal weighting function that assigns a weight based on a timing of an interaction relative to a launch time of a live title. For example, ƒ(Δ_{i,j}) can assign higher weights to interactions occurring closer to the launch time and lower weights to interactions occurring further from the launch time. In some embodiments, demand features 903 capture both an intensity of prelaunch engagement (e.g., viewer engagement with prelaunch content items) and a temporal proximity of such engagement to a launch time.

At-launch demand forecast module 911 is a module of CDN resource allocator 554 that uses at-launch demand forecast model 522 to process demand features 903 and generate an at-launch demand forecast 904 and an at-launch demand distribution 905. In some embodiments, at-launch demand forecast model 522 processes demand features 903 and generates at-launch demand forecast 904. In some embodiments, for a given live title i, at-launch demand forecast model 522 processes demand features 903 xᵢ, which include aggregated prelaunch interaction signals 901, to generate at-launch demand forecast 904, for example, according to:

D\hat{ }ᵢ=g_{θ}(xᵢ), (Equation 20)

where g_{θ} denotes at-launch demand forecast model 522 parameterized by θ, and D\hat{ }ᵢ an at-launch demand forecast 904 corresponding to an expected number of members that will view the live title i over a time horizon beginning at a launch timestamp and extending up to a fixed number of hours after the launch timestamp (e.g., twenty-four hours after the launch timestamp). In some embodiments, at-launch demand forecast module 911 uses one or more quantile regression techniques to process at-launch demand forecast 904 and generate an at-launch demand distribution 905 representing uncertainty or variability in predicted demand. For example, at-launch demand distribution 905 can include one or more quantile-based estimates D\hat{ }ᵢ^{(q)}, where q denotes a quantile. In some embodiments, the at-launch demand distribution 905 includes multiple quantile estimates that characterize a range of expected demand outcomes.

Adjusted demand forecast generator 912 is a module of CDN resource allocator 554 that processes one or more historical similar events 906 and one or more domain heuristics 907 and generates an adjusted demand forecast 908. In some embodiments, for a given live title i, adjusted demand forecast generator 912 adjusts at-launch demand forecast 904 based on information derived from historical similar events 906 and domain-specific rules included in domain heuristics 907. For example, adjusted demand forecast generator 912 can generate an adjusted demand forecast 908 according to:

D\tilde{ }ᵢ=αD\hat{ }ᵢ+(1−α)hᵢ, (Equation 21)

where D\tilde{ }ᵢ denotes adjusted demand forecast 908, α∈[0,1] denotes a weighting parameter, and hᵢ denotes an adjustment value derived from historical similar events 906 and domain heuristics 907. In some embodiments, historical similar events 906 include, without limitation, data associated with prior live events that share one or more characteristics with the live title i, such as event type, participants, time of day, or regional interest. In some embodiments, adjusted demand forecast generator 912 computes the adjustment value hᵢ based on viewer demand from historical similar events 906. For example, adjusted demand forecast generator 912 can compute the adjustment value according to:

$${h}_{i} = \frac{1}{K} {\sum }_{k = 1}^{K} {D}_{k}^{obs} , \qquad ( Equation 22 )$$

where Dₖ^{obs} denotes viewer demand for a k-th similar historical event and K denotes a number of historical similar events 906. In some embodiments, domain heuristics 907 include, without limitation, rule-based adjustments derived from domain knowledge, such as expected demand amplification due to promotional campaigns, anticipated spikes based on event popularity, adjustments for external factors, and/or the like. In some examples, domain heuristics 907 are incorporated as scaling or offset factors applied to the demand forecast, for example, according to:

hᵢ=γᵢ·D\hat{ }ᵢ+δᵢ, (Equation 23)

where γᵢ and δᵢ are heuristic parameters. In some embodiments, domain heuristics 907 are derived from domain experts or content teams that analyze historical similar events 906 and apply human-in-the-loop adjustments to the demand forecast.

CDN resource plan generator 913 is a module of CDN resource allocator 554 that processes adjusted demand forecast 908 and CDN configuration 909 and generates CDN resource plan 921. In some embodiments, CDN configuration 909 includes, without limitation, one or more configuration parameters, such as average bitrate per member, server capacity, geographic distribution constraints, and/or network bandwidth limits. In some embodiments, for a given candidate live title i, CDN resource plan generator 913 determines resource requirements based on an adjusted demand forecast 908 D\tilde{ }ᵢ and the configuration parameters associated with a content delivery network. In some embodiments, CDN resource plan generator 913 computes a required network bandwidth according to:

Bᵢ=D\tilde{ }ᵢ·b⁻, (Equation 24)

where Bᵢ denotes required bandwidth for the live title i, and b⁻ denotes an average bitrate per member. In some embodiments, CDN resource plan generator 913 determines a required number of CDN resources, such as servers or edge nodes, according to:

$${N}_{i} = ⌈ \frac{{D}_{i}^{\sim}}{K} ⌉ , \qquad ( Equation 25 )$$

where Nᵢ denotes a number of required CDN resource units and K denotes a capacity of a resource unit. In some embodiments, CDN resource plan generator 913 generates CDN resource plan 921 based on the computed resource requirements and CDN configuration 909 according to:

Rᵢ=ψ(D\tilde{ }ᵢ,C), (Equation 26)

where Rᵢ denotes CDN resource plan 921 for the live title i, C denotes CDN configuration 909, and ψ(⋅) denotes a planning function that allocates resources across one or more regions or network locations.

CDN resource allocator 914 is a module of CDN resource allocator 554 that allocates CDN resources to live titles included in upcoming live titles metadata 524 based on CDN resource plan 921 to generate allocated CDN resources 922. In some embodiments, for a given live title i, CDN resource allocator 914 receives a CDN resource plan 921 Rᵢ and assigns one or more resource units across a CDN according to the plan. For example, CDN resource allocator 914 can allocate bandwidth, server capacity, and/or edge node resources according to Aᵢ=Γ(Rᵢ), where Aᵢ denotes allocated CDN resources 922 for live title i, and Γ(⋅) denotes an allocation function. In some embodiments, the allocation function Γ(⋅) includes mapping required bandwidth and capacity values to specific infrastructure resources. For example, the allocation function can assign a number of edge servers according to Aᵢ={Nᵢ servers, Bᵢ bandwidth}, where Nᵢ and Bᵢ are determined from CDN resource plan 921. In some embodiments, the allocation function selects specific CDN nodes or regions based on geographic demand, such as Aᵢ={(r,N_{i,r},B_{i,r})}_{r∈R}, where r denotes a region and N_{i,r} and B_{i,r} denote allocated server capacity and bandwidth for region r.

In some embodiments, the allocation function prioritizes allocation to regions with higher predicted demand or lower available capacity. In some embodiments, CDN resource allocator 914 distributes allocated CDN resources 922 across multiple geographic regions or network locations based on demand distribution and CDN configuration parameters. For example, allocated CDN resources 922 can be distributed according to A_{i,r}=ρᵣ·Aᵢ, where A_{i,r} denotes allocated CDN resources 922 for region r, and ρᵣ denotes a proportion of demand associated with the region. In some embodiments, the proportions ρᵣ are determined based on historical regional demand patterns, predicted regional interest, and/or network topology constraints. In some embodiments, the allocated CDN resources 922 support presentation of one or more prelaunch content items. In some embodiments, content associated with the prelaunch content items is preloaded onto selected CDN nodes prior to the launch time to reduce latency and improve playback performance.

### Training At-Launch Demand Forecast Model Based on At-Launch Demand Forecast and Live Launch Telemetry

FIG. 9B is a more detailed illustration of model trainer 516 training at-launch demand forecast model 522, according to various embodiments. In operation, post-launch demand and quality of experience (QoE) metrics calculator 555 calculates post-launch demand and QoE metrics 932 based on live launch telemetry 931. Loss calculator 517 calculates loss 933 based on at-launch demand forecast 904 and post-launch demand and QoE metrics 932. Model trainer 516 updates one or more parameters of at-launch demand forecast model 522 based on loss 933.

Post-launch demand and QoE metrics calculator 555 calculates post-launch demand and QoE metrics 932 based on live launch telemetry 931. In some embodiments, live launch telemetry 931 includes, without limitation, streaming session data, playback events, join times, session durations, concurrent viewer counts, bitrate selections, buffering events, rebuffering rates, playback errors, network performance metrics, device information, geographic information, and/or user engagement signals associated with members interacting with a live title (e.g., prelaunch content item). In some embodiments, post-launch demand is calculated as a total number of members that viewed a live title over a time horizon beginning at a launch timestamp and extending up to a fixed number of hours after launch, such as twenty-four hours after launch. For example, post-launch demand can be computed according to:

$${D}_{i}^{obs} = {\int }_{{T}_{i}}^{{T}_{i} + 24 h} {v}_{i} ( t ) dt , \qquad ( Equation 27 )$$

where Dᵢ^{obs} denotes viewer demand for live title i,Tᵢ denotes a launch time, and vᵢ(t) denotes a number of active viewers at time t. In some embodiments, QoE metrics are calculated based on live launch telemetry 931 to characterize a quality of streaming experienced by members. For example, QoE can be represented as a vector Qᵢ=(q_{i,1}, q_{i,2}, . . . , q_{i,m}), where q_{i,k} corresponds to a QoE metric, such as buffering rate, average bitrate, startup delay, playback failure rate, or session stability. In some embodiments, post-launch demand and QoE metrics 932 are also provided to recommendation systems to improve future prelaunch recommendations, and such provision forms a feedback loop that improves both recommendation and demand forecasting performance over time.

Loss calculator 517 calculates loss 933 based on at-launch demand forecast 904 and post-launch demand and QoE metrics 932. In some embodiments, for a given live title i, loss calculator 517 computes a demand forecasting loss based on a difference between at-launch demand forecast 904 and observed post-launch demand included in post-launch demand and QoE metrics 932. For example, loss calculator 517 can compute a demand forecasting loss according to:

$${L}_{i}^{demand} = {l}_{D} ( {D}_{i}^{\hat{}} , {D}_{i}^{obs} ) , \qquad ( Equation 28 )$$

where l_{D}(⋅,⋅) denotes a demand forecasting loss function, such as a squared error, absolute error, quantile regression loss, and/or the like. In some embodiments, loss calculator 517 further computes a QoE loss based on one or more QoE metrics included in post-launch demand and QoE metrics 932. For example, loss calculator 517 can compute a QoE loss according to:

$${L}_{i}^{QoE} = ρ ( {Q}_{i} ) , \qquad ( Equation 29 )$$

where ρ(⋅) denotes a function that maps the observed QoE metrics to a scalar penalty or calibration term. In some embodiments, larger buffering rates, larger startup delays, larger playback failure rates, or reduced bitrate quality increase the QoE loss. In some embodiments, loss calculator 517 combines the demand forecasting loss and the QoE loss to generate a loss for each live title according to:

$${L}_{i} = {L}_{i}^{demand} + λ {L}_{i}^{QoE} , \qquad ( Equation 30 )$$

where λ is a weighting factor controlling a contribution of the QoE loss. In some embodiments, loss calculator 517 aggregates the losses across multiple live titles to generate an overall loss 933, for example, according to L=Σᵢ Lᵢ.

In some embodiments, model trainer 516 updates one or more parameters of at-launch demand forecast model 522 based on loss 933. In some embodiments, for a given set of parameters θ of at-launch demand forecast model 522, model trainer 516 updates the parameters using an objective function derived from loss 933 according to:

θ←θ−η∇_{θ}L(θ), (Equation 31)

where η denotes a learning rate and ∇_{θ}L(θ) denotes a gradient of loss 933 with respect to parameters θ. In some embodiments, model trainer 516 applies one or more optimization techniques, including stochastic gradient descent, adaptive optimization methods, or regularization techniques, to improve convergence.

FIG. 10 sets forth a flow diagram of method steps for generating training data 523, according to various embodiments. Although the method steps are described in conjunction with the systems of FIGS. 1-9B, persons skilled in the art will understand that any system configured to perform the method steps in any order falls within the scope of the present disclosure.

As shown, a method 1000 begins with step 1001, where training data generator 518 receives upcoming live titles metadata 524, content metadata 525, content embeddings 519, member metadata 527, and cross content member interactions 526. Upcoming live titles metadata 524 includes event identifiers, scheduled launch times, event durations, participant or talent information, content descriptors, such as titles, genres, and/or synopses, promotional assets including images and trailers, regional availability information, and any additional attributes associated with one or more upcoming live titles. Content metadata 525 stored in data store 520 includes, without limitation, content identifiers, titles, genres, categories, synopses, cast and crew information, release dates, duration, language and regional availability information, content ratings, and other descriptive attributes associated with one or more content items (e.g., a single, discrete unit of media, such as a specific movie, episode, or live event). Cross content member interactions 526 includes records of member interactions with content across various content types (e.g., a category of content items, such as movies, TV shows, or live events), including viewing history, playback events, clicks, search queries, impressions, browsing activity, additions to a watchlist or “my list,” reminder registrations, ratings or feedback signals, timestamps associated with such interactions, and contextual information describing how and when the interactions occurred, all of which could be used to model member preferences and engagement patterns. Member metadata 527 includes one or more attributes associated with a member, such as historical interaction patterns, content preference profiles, viewing history, search history, watchlist additions, reminder registrations, device information, geographic location or region, language preferences, subscription tier, session activity patterns, and/or temporal engagement characteristics. Content embeddings 519 include one or more numerical representations of content items, such as dense vector embeddings or discrete feature sequences, generated, for example, using one or more machine learning models to capture semantic, visual, audio, and/or textual characteristics of the content items. In some embodiments, content metadata 525 and content embeddings 519 include attributes specific to live events, including timing, participants, and other characteristics that distinguish live content from on-demand content.

At step 1002, prelaunch title detector 613 detects prelaunch live titles 602 based on upcoming live titles metadata 524. In some embodiments, prelaunch title detector 613 detects prelaunch live titles 602 based on upcoming live titles metadata 524 by identifying content items having a launch time later than a current time. In some embodiments, upcoming live titles metadata 524 includes, for each content item i, a corresponding launch time Tᵢ, and prelaunch title detector 613 compares Tᵢ to a current time t to determine whether the content item is a prelaunch live title 602. For example, prelaunch title detector 613 can generate a set of prelaunch live titles 602 according to L^{pre}={i|Tᵢ>t}, where L^{pre} denotes the set of detected prelaunch live titles 602. In some embodiments, prelaunch title detector 613 further filters or updates the set of prelaunch live titles 602 based on additional metadata attributes, such as regional availability or scheduling updates.

At step 1003, candidate title generator 614 generates candidate live titles 603 based on prelaunch live titles 602, cross content member interactions 526, and content embeddings 519. In some embodiments, candidate title generator 614 retrieves, for a given member u, a subset of prelaunch live titles 602 that are likely to be relevant to the member based on historical interaction patterns and similarity between content items. For example, let Iᵤ denote cross content member interactions 526 associated with member u. Candidate title generator 614 can generate a candidate live titles 603 set Cᵤ according to Cᵤ=Retrieve(u,L^{Pre},Iᵤ, E), where E={Eᵢ} denotes content embeddings 519 associated with prelaunch live titles 602. In some embodiments, the retrieval operation uses one or more similarity computations between content embeddings 519, such as sim(i,j)= [symbol] Eᵢ, Eⱼ [symbol] , where [symbol] .,. [symbol] denotes inner product, to identify prelaunch live titles 602 i that are similar to content items j previously interacted with by the member. For example, for a given member u having a set of previously interacted content items Iᵤ, candidate title generator 614 can compute an aggregated similarity score for each prelaunch live title 602 i according to S_{u,i}=Σ_{j∈I}_{ᵤ} w_{u,j}· [symbol] Eᵢ,Eⱼ [symbol] , where w_{u,j} represents a weight associated with an interaction of the member u with content item j. In some embodiments, candidate live titles 603 are selected based on the aggregated similarity scores, such as by selecting a subset of prelaunch live titles 602 having the highest values of S_{u,i}.

At step 1004, prelaunch feature generator 553 generates prelaunch features 604 based on candidate live titles 603, cross content member interactions 526, member metadata 527, content embeddings 519, and content metadata 525. In some embodiments, for a given member u and a candidate live title 603 i, prelaunch feature generator 553 constructs a feature vector that encodes relationships between the member and candidate live title 603 based on historical interactions, content representations, and metadata attributes. In some embodiments, candidate live title 603 corresponds to a live event that is not yet available for playback, and prelaunch features 604 are generated based on member interactions with preview experiences associated with candidate live title 603 prior to a launch time. For example, prelaunch features 604 can be generated according to Equation 1. In some embodiments, the feature vector x_{u,i} included in prelaunch features 604 further includes similarity-based features derived from content embeddings 519, interaction-based features derived from cross content member interactions 526 Iᵤ, and metadata-based features derived from content embeddings 519 Mᵢ.

At step 1005, prelaunch content recommender 552 generates, using ranking models 521, prelaunch content recommendations 605 based on prelaunch features 604 and candidate live titles 603. In some embodiments, ranking models 521 process prelaunch features 604 and generate one or more ranking scores. In some embodiments, ranking models 521 include, without limitation, a row ranking model and a title ranking model. In some embodiments, for a given member u and a candidate live title i, ranking models 521 process prelaunch features 604 to generate the ranking scores according to Equation 2. In some embodiments, the title ranking model ƒ_{θ}_{ₜ} generates the ranking scores representing a predicted likelihood that the member will engage with a candidate live title 603, while the row ranking model ƒ_{θ}_{ᵣ} generates the ranking scores representing a relevance of a content row or grouping associated with candidate live titles 603. In some embodiments, the resulting ranking scores are combined to generate a final ranking score according to Equation 3. In some embodiments, prelaunch content recommender 552 ranks candidate live titles 603 for the member u based on the final ranking scores s_{u,i}, such that Equation 4 is satisfied. In some embodiments, prelaunch content recommendations 605 are generated by selecting a subset of the ranked candidate live titles 603, such as top-K titles Rᵤ=TopK(πᵤ), where Rᵤ denotes prelaunch content recommendations 605. In some embodiments, prelaunch content recommender 552 further applies exploration strategies to adjust the ranking scores to generate adjusted ranking scores, including modifying scores or selection probabilities for one or more candidate live titles 603 based on exploration parameters, such as uncertainty, recency, or timeliness associated with the candidate live titles 603. For example, a modified score can be computed according to Equation 5. In some embodiments, the exploration term is determined based on a bandit algorithm, such as a UCB, Boltzmann, or Thompson sampling approach, such that candidate live titles with higher uncertainty or limited prior interaction data are more likely to be explored. In some embodiments, the bandit algorithm updates selection parameters based on observed prelaunch interaction signals from the member, such that probabilities of selecting candidate live titles 603 are adjusted over time in response to member interactions. In some embodiments, prelaunch content recommendations 605 are selected based on the modified scores or probabilities and are provided for presentation to the member via a user interface, such as a homepage or recommendation surface, prior to candidate live titles 603 becoming playable.

At step 1006, prelaunch label generator 616 generates prelaunch labels 607 based on prelaunch interaction signals 606 and prelaunch content recommendations 605. Prelaunch interaction signals 606 received from one or more I/O devices, such as client devices including mobile devices, smart televisions, set-top boxes, personal computers, tablets, and/or web browsers, include, without limitation, user interactions with prelaunch content recommendations 605, such as clicks, selections, navigation events, additions to a watchlist or “my list,” reminder registrations, search queries, and associated timestamps indicating when such interactions occurred. In some embodiments, for a given member u and a recommended candidate live title i, prelaunch label generator 616 identifies prelaunch interaction signals 606 associated with the presentation of the recommended candidate live title 603 and aggregates such signals over a prelaunch time window. For example, let

$${S}_{u , i} = {\{ ( {c}_{u , i , j} , {τ}_{u , i , j} ) \}}_{j = 1}^{{N}_{u , i}}$$

denote the set of prelaunch interaction signals 606 for member u and recommended candidate live title i included in prelaunch content recommendations 605, where c_{u,i,j} denotes a signal type (e.g., click, reminder registration, watchlist addition, impression, and/or the like) and τ_{u,i,j} denotes a corresponding timestamp. Prelaunch label generator 616 can generate a prelaunch label 607 according to Equation 6. In some embodiments, the mapping function g(⋅) in Equation 6 assigns weights to different interaction types to generate weighted interaction types and aggregates the weighted interaction types to generate a scalar prelaunch label 607, such as Equation 7. In some embodiments, prelaunch label generator 616 further incorporates the timestamps included in prelaunch interaction signals 606. For example, interactions occurring closer to a launch time Tᵢ of a recommended candidate live title 603 can be assigned greater influence, such as Equation 8. In some embodiments, prelaunch label generator 616 generates different label types, including binary labels, multi-level labels, or continuous-valued labels, depending on the aggregation strategy. For example, a binary prelaunch label 607 can be generated according to Equation 9, while a continuous prelaunch label 607 can represent an intensity of engagement based on aggregated prelaunch interaction signals 606. In some embodiments, prelaunch label generator 616 assigns prelaunch label 607 values based on a type of prelaunch interaction signals 606, such as assigning a higher label value for a reminder registration or a “my list” addition relative to a click or impression. For example, prelaunch label generator 616 can assign prelaunch label 607 values according to Equation 10.

At step 1007, anticipation reward calculator 617 generates anticipation rewards 608 based on prelaunch labels 607 and content metadata 525. In some embodiments, for a given member u and a recommended candidate live title i, anticipation reward calculator 617 determines a reward value based on a timing of an interaction relative to a launch time of the recommended candidate live title 603. For example, content metadata 525 includes a launch time Tᵢ associated with the recommended candidate live title i, and each prelaunch label 607 y_{u,i} is associated with one or more interaction timestamps τ_{u,i,j}. Anticipation reward calculator 617 computes a temporal distance, such as according to Equation 11. In some embodiments, anticipation reward calculator 617 applies a reward function that varies based on the temporal distance to generate a reward value r_{u,i,j}=ƒᵢ(Δ_{u,i,j}), where ƒᵢ(⋅) is a time-dependent reward function associated with candidate live title i. In some embodiments, the reward function increases as the interaction time approaches the launch time, reaches a peak value at or near the launch time, and decreases after the launch time. In some embodiments, different candidate live titles 603 are associated with different reward functions ƒᵢ(⋅) based on content attributes included in content metadata 525, such that content items having higher time sensitivity are associated with reward functions that exhibit sharper peaks around the launch time. In some embodiments, anticipation reward calculator 617 aggregates reward values across multiple interaction signals associated with the same member and recommended candidate live titles 603 to generate a final anticipation reward 608, such as Equation 12 or, in some embodiments, Equation 13. In some embodiments, anticipation reward calculator 617 further adjusts the reward based on attributes of the recommended candidate live titles 603 included in content metadata 525, such as a type of live event, duration, and/or timeliness characteristics, such that different categories of content can be associated with different reward scaling behaviors. In some embodiments, anticipation rewards 608 are normalized relative to a baseline value. In some embodiments, anticipation rewards 608 reflect a contribution of prelaunch interactions to long-term member satisfaction, such that interactions indicating higher anticipation for a live event are assigned greater influence during training of ranking models 521.

At step 1008, training data generator 518 stores anticipation rewards 608, candidate live titles 603, and prelaunch labels 607 in training data 523.

FIG. 11 sets forth a flow diagram of method steps for training ranking models 521, according to various embodiments. Although the method steps are described in conjunction with the systems of FIGS. 1-9B, persons skilled in the art will understand that any system configured to perform the method steps in any order falls within the scope of the present disclosure.

As shown, a method 1100 begins with step 1101, where model trainer 516 is initialized. In some embodiments, model trainer 516 initializes batch sizes of the training examples. In some embodiments, model trainer 516 initializes the learning rate η in Equation 17. In some embodiments, model trainer 516 initializes learning rates ηₜ and ηᵣ in Equation 18. In some embodiments, model trainer 516 initializes the threshold number of training iterations.

At step 1102, prelaunch feature generator 553 generates prelaunch features 705 based on content metadata 525, content embeddings 519, cross content member interactions 526, member metadata 527, and candidate lives titles 702 included in training data 523. In some embodiments, for a given member u and a candidate live title 702 i, prelaunch feature generator 553 constructs a feature vector that encodes relationships between the member and candidate live title 702 based on historical interactions, content representations, and metadata attributes. For example, prelaunch features 705 can be generated according to Equation 1. In some embodiments, the feature vector x_{u,i} included in prelaunch features 705 further includes similarity-based features derived from content embeddings 519, interaction-based features derived from cross content member interactions 526 Iᵤ, and metadata-based features derived from content metadata 525 Mᵢ.

At step 1103, ranking models 521 generate ranking scores 706 based on prelaunch features 705. In some embodiments, ranking models 521 include a row ranking model and a title ranking model. In some embodiments, for a given member u and a candidate live title 702 i, ranking models 521 process prelaunch features 705 to generate ranking scores 706 according to Equation 2. In some embodiments, the title ranking model ƒ_{θ}_{ₜ}, generates ranking scores 706 representing a predicted likelihood that the member will engage with a candidate live title 702, while the row ranking model ƒ_{θ}_{ᵣ} generates ranking scores 706 representing a relevance of a content row or grouping associated with candidate live titles 702. In some embodiments, the resulting ranking scores 706 are combined to generate a final ranking score 706 according to Equation 3.

At step 1104, loss calculator 517 calculates loss 709 based on ranking scores 706, prelaunch labels 707, and anticipation rewards 708 included in training data 523. In some embodiments, loss calculator 517 computes a loss between the generated ranking scores 706 and corresponding prelaunch labels 707, for example as described in Equation 14. In some embodiments, anticipation rewards 708 are applied as multiplicative data weights to adjust contributions of different training examples. For example, weighted losses can be computed according to Equation 15. In some embodiments, anticipation rewards 708 r_{u,i} are normalized relative to a baseline value, such that values greater than the baseline increase an influence of a corresponding training example and values less than the baseline decrease the influence of the corresponding training example. In some embodiments, training examples associated with interactions occurring closer to a launch time receive higher weights, which increases the influence during model training. In some embodiments, loss calculator 517 aggregates weighted losses across members and candidate live titles 702 to generate loss 709, for example as described in Equation 16. In some embodiments, weighting of training examples using anticipation rewards 708 aligns optimization of ranking models 521 with long-term member satisfaction objectives by prioritizing recommendations that drive meaningful prelaunch engagement for live events.

At step 1105, model trainer 516 updates parameters of ranking models 521 based on loss 709. In some embodiments, for a given ranking model 521 parameterized by θ, model trainer 516 updates the parameters based on loss 709 according to Equation 17. In some embodiments, separate parameter updates are performed for different ranking models 521, such as the title ranking model and the row ranking model, for example, according to Equation 18. In some embodiments, model trainer 516 performs updates using mini-batches of training data 523, such that gradients are computed over subsets of training examples to improve computational efficiency. In some embodiments, one or more optimization techniques are applied, including stochastic gradient descent, adaptive optimization methods, or regularization techniques, to improve convergence and generalization.

At step 1106, model trainer 516 determines whether to continue training. In some embodiments, the one or more stopping criteria include reaching a threshold number of training iterations, convergence of loss 709, stabilization of validation performance, or satisfaction of a predefined performance metric. Upon satisfying the one or more stopping criteria, model trainer 516 stores ranking models 521 in data store 520 or elsewhere.

FIG. 12 sets forth a flow diagram of method steps for generating prelaunch content recommendations 802, according to various embodiments. Although the method steps are described in conjunction with the systems of FIGS. 1-9B, persons skilled in the art will understand that any system configured to perform the method steps in any order falls within the scope of the present disclosure.

As shown, a method 1200 begins with step 1201, where prelaunch content recommendation application 551 receives content metadata 525, content embeddings 519, member metadata 527, cross content member interactions 801, and candidate live titles 803. In some embodiments, cross content member interactions 801 are received from one or more I/O devices, such as client devices including mobile devices, smart televisions, set-top boxes, personal computers, tablets, and/or web browsers, and include, without limitation, records of member interactions with content items across multiple content types, such as viewing history, playback events, clicks, search queries, impressions, browsing activity, additions to a watchlist or “my list,” reminder registrations, ratings or feedback signals, and timestamps associated with such interactions. Candidate live titles 803 include, without limitation, a subset of content items corresponding to upcoming live titles selected for evaluation for a given member, where such content items are associated with respective content identifiers, launch times, content embeddings 519, and content metadata 525.

At step 1202, prelaunch feature generator 553 generates prelaunch features 804 based on candidate live titles 803, cross content member interactions 801, member metadata 527, content embeddings 519, and content metadata 525. In some embodiments, for a given member u and a candidate live title 803 i, prelaunch feature generator 553 constructs a feature vector that encodes relationships between the member and candidate live title 803 based on historical interactions, content representations, and metadata attributes. For example, prelaunch features 804 can be generated according to Equation 1. In some embodiments, the feature vector x_{u,i} included in prelaunch features 804 further includes similarity-based features derived from content embeddings 519, interaction-based features derived from cross content member interactions 801 Iᵤ, and metadata-based features derived from content metadata 525 Mᵢ.

At step 1203, prelaunch content recommender 552 generates, using ranking models 521, prelaunch content recommendations 802 based on prelaunch features 804 and candidate live titles 803. In some embodiments, ranking models 521 process prelaunch features 804 and generate one or more ranking scores. In some embodiments, ranking models 521 include a row ranking model and a title ranking model. In some embodiments, for a given member u and a candidate live title 803 i, ranking models 521 process prelaunch features 804 to generate the ranking scores according to Equation 2. In some embodiments, the title ranking model ƒ_{θ}_{ₜ} generates the ranking scores representing a predicted likelihood that the member will engage with a candidate live title 803, while the row ranking model ƒ_{θ}_{ᵣ} generates the ranking scores representing a relevance of a content row or grouping associated with candidate live titles 803. In some embodiments, the resulting ranking scores are combined to generate a final ranking score according to Equation 3. In some embodiments, prelaunch content recommender 552 ranks candidate live titles 803 for the member u based on the final ranking scores s_{u,i} such that Equation 4 is satisfied. In some embodiments, prelaunch content recommendations 802 are generated by selecting a subset of the ranked candidate live titles 803, such as top-K titles Rᵤ=TopK(πᵤ), where Rᵤ denotes prelaunch content recommendations 802. In some embodiments, prelaunch content recommender 552 further applies exploration strategies to adjust the ranking scores to generate adjusted ranking scores, including modifying scores or selection probabilities for one or more candidate live titles 803 based on exploration parameters, such as uncertainty, recency, or timeliness associated with candidate live titles 803. For example, a modified score can be computed according to Equation 5. In some embodiments, the exploration term is determined based on a bandit algorithm, such as a UCB, Boltzmann, or Thompson sampling approach, such that candidate live titles 803 with higher uncertainty or limited prior interaction data are more likely to be explored. In some embodiments, the bandit algorithm updates selection parameters based on observed prelaunch interaction signals from the member, such that probabilities of selecting candidate live titles 803 are adjusted over time in response to member interactions. In some embodiments, prelaunch content recommendations 802 are selected based on the modified scores or probabilities and are provided for presentation to the member via a user interface, such as a homepage or recommendation surface, prior to candidate live titles 803 becoming playable.

FIG. 13 sets forth a flow diagram of method steps for generating allocated CDN resources 922, according to various embodiments. Although the method steps are described in conjunction with the systems of FIGS. 1-9B, persons skilled in the art will understand that any system configured to perform the method steps in any order falls within the scope of the present disclosure.

As shown, a method 1300 begins with step 1301, where CDN resource allocator 554 receives prelaunch interaction signals 901, upcoming live title metadata 524, historical similar events 906, domain heuristics 907, and CDN configuration 909. In some embodiments, historical similar events 906 include, without limitation, data associated with prior live events that share one or more characteristics with the candidate live title i, such as event type, participants, time of day, or regional interest. In some embodiments, CDN configuration 909 includes one or more configuration parameters, such as average bitrate per member, server capacity, geographic distribution constraints, and/or network bandwidth limits. In some embodiments, domain heuristics 907 include rule-based adjustments derived from domain knowledge, such as expected demand amplification due to promotional campaigns, anticipated spikes based on event popularity, adjustments for external factors, and/or the like. In some embodiments, domain heuristics 907 are derived from domain experts or content teams that analyze similar historical events 906 and apply human-in-the-loop adjustments to the demand forecast.

At step 1302, demand feature generator 910 generates demand features 903 based on prelaunch interaction signals 901 and upcoming live titles metadata 524. In some embodiments, for a given live title i included in upcoming live titles metadata 524, demand feature generator 910 aggregates prelaunch interaction signals 901 associated with the live title and combines such signals with metadata attributes to construct a feature vector usable for demand estimation. For example, let

$${S}_{i} = {\{ ( {c}_{i , j} , {τ}_{i , j} ) \}}_{j = 1}^{{N}_{i}}$$

denote prelaunch interaction signals 901 associated with the live title i, where c_{i,j} denotes a type of interaction signal and τ_{i,j} denotes a corresponding timestamp. In some embodiments, demand feature generator 910 computes temporal distances relative to a launch time Tᵢ included in upcoming live titles metadata 524, for example, according to Equation 11. In some examples, demand features 903 are generated according to xᵢ=φ(Sᵢ, Mᵢ), where Mᵢ denotes metadata associated with the live title i. In some embodiments, the feature vector xᵢ includes aggregated interaction counts, such as counts of reminder registrations, clicks, and watchlist additions, as well as time-weighted interaction signals based on Δ_{i,j}, and metadata-based features derived from Mᵢ. In some embodiments, watchlist additions (e.g., “my-list” interactions) are assigned greater importance relative to other interaction types as leading indicators of demand, for example, as described in Equation 19. The function ƒ(Δ_{i,j}) in Equation 19 can assign higher weights to interactions occurring closer to the launch time and lower weights to interactions occurring further from the launch time. In some embodiments, demand features 903 capture both an intensity of prelaunch engagement and a temporal proximity of such engagement to a launch time.

At step 1303, at-launch demand forecast module 911 generates, using at-launch demand forecast model 522, at-launch demand forecast 904 and at-launch demand distribution 905 based on demand features 903. In some embodiments, at-launch demand forecast model 522 processes demand features 903 and generates at-launch demand forecast 904. In some embodiments, for a given candidate live title i, at-launch demand forecast model 522 processes demand features 903 xᵢ, which include aggregated prelaunch interaction signals 901, to generate at-launch demand forecast 904, for example, according to Equation 20. In some embodiments, at-launch demand forecast module 911 uses one or more quantile regression techniques to process at-launch demand forecast 904 and generate an at-launch demand distribution 905 representing uncertainty or variability in predicted demand. For example, at-launch demand distribution 905 can include one or more quantile-based estimates D\hat{ }ᵢ^{(q)}, where q denotes a quantile. In some embodiments, the at-launch demand distribution 905 includes multiple quantile estimates that characterize a range of expected demand outcomes.

At step 1304, adjusted demand forecast generator 912 generates adjusted demand forecast 908 based on historical similar events 906 and domain heuristics 907. In some embodiments, for a given live title i, adjusted demand forecast generator 912 adjusts at-launch demand forecast 904 based on information derived from historical similar events 906 and domain-specific rules included in domain heuristics 907. For example, adjusted demand forecast generator 912 can generate an adjusted demand forecast 908 according to Equation 21. In some embodiments, adjusted demand forecast generator 912 computes the adjustment value hᵢ based on viewer demand from historical similar events 906. For example, adjusted demand forecast generator 912 can compute the adjustment value according to Equation 22. In some examples, domain heuristics 907 are incorporated as scaling or offset factors applied to the demand forecast, for example, according to Equation 23.

At step 1305, CDN resource plan generator 913 generates CDN resource plan 921 based on adjusted demand forecast 908 and CDN configuration 909. In some embodiments, for a given live title i, CDN resource plan generator 913 determines resource requirements based on an adjusted demand forecast 908 D\tilde{ }ᵢ and the configuration parameters associated with a content delivery network. In some embodiments, CDN resource plan generator 913 computes a required network bandwidth according to Equation 24. In some embodiments, CDN resource plan generator 913 determines a required number of CDN resources, such as servers or edge nodes, according to Equation 25. In some embodiments, CDN resource plan generator 913 generates CDN resource plan 921 based on the computed resource requirements and CDN configuration 909 according to Equation 26.

At step 1306, CDN resource allocator 914 allocates CDN resources to live titles included in upcoming live titles metadata 524 based on CDN resource plan 921 to generate allocated CDN resources 922. In some embodiments, for a given live title i, CDN resource allocator 914 receives a CDN resource plan 921 Rᵢ and assigns one or more resource units across a CDN according to the plan. For example, CDN resource allocator 914 can allocate bandwidth, server capacity, and/or edge node resources according to Aᵢ=Γ(Rᵢ), where Aᵢ denotes allocated CDN resources 922 for live title i, and Γ(⋅) denotes an allocation function. In some embodiments, the allocation function Γ(⋅) includes mapping required bandwidth and capacity values to specific infrastructure resources. For example, the allocation function can assign a number of edge servers according to Aᵢ={Nᵢ servers, Bᵢ bandwidth}, where Nᵢ and Bᵢ are determined from CDN resource plan 921. In some embodiments, the allocation function selects specific CDN nodes or regions based on geographic demand, such as Aᵢ={(r,N_{i,r},B_{i,r})}_{r∈R}, where r denotes a region and N_{i,r} and B_{i,r} denote allocated server capacity and bandwidth for region r. In some embodiments, the allocation function prioritizes allocation to regions with higher predicted demand or lower available capacity. In some embodiments, CDN resource allocator 914 distributes allocated CDN resources 922 across multiple geographic regions or network locations based on demand distribution and CDN configuration parameters. For example, allocated CDN resources 922 can be distributed according to A_{i,r}=ρᵣ·Aᵢ, where A_{i,r} denotes allocated CDN resources 922 for region r, and ρᵣ denotes a proportion of demand associated with the region. In some embodiments, the proportions ρᵣ are determined based on historical regional demand patterns, predicted regional interest, and/or network topology constraints. In some embodiments, the allocated CDN resources 922 support presentation of one or more prelaunch content items. In some embodiments, content associated with the prelaunch content items is preloaded onto selected CDN nodes prior to the launch time to reduce latency and improve playback performance.

FIG. 14 sets forth a flow diagram of method steps for training at-launch demand forecast model 522, according to various embodiments. Although the method steps are described in conjunction with the systems of FIGS. 1-9B, persons skilled in the art will understand that any system configured to perform the method steps in any order falls within the scope of the present disclosure.

As shown, a method 1400 begins with step 1401, where post-launch demand and QoE metrics calculator 555 receives live launch telemetry 931 and loss calculator 517 receives at-launch demand forecast 904. In some embodiments, live launch telemetry 931 includes streaming session data, playback events, join times, session durations, concurrent viewer counts, bitrate selections, buffering events, rebuffering rates, playback errors, network performance metrics, device information, geographic information, and/or user engagement signals associated with members interacting with a live title. In some embodiments, at-launch demand forecast 904 is generated as described in conjunction with step 1303 of method 1300.

At step 1402, post-launch demand and QoE metrics calculator 555 calculates post-launch demand and QoE metrics 932 based on live launch telemetry 931. In some embodiments, post-launch demand is calculated as a total number of members that viewed a live title over a time horizon beginning at a launch timestamp and extending up to a fixed number of hours after launch, such as twenty-four hours after launch. For example, post-launch demand can be computed according to Equation 27. In some embodiments, QoE metrics are calculated based on live launch telemetry 931 to characterize a quality of streaming experienced by members. For example, QoE can be represented as a vector Qᵢ=(q_{i,1}, q_{i,2}, . . . , q_{i,m}), where q_{i,k} corresponds to a QoE metric, such as buffering rate, average bitrate, startup delay, playback failure rate, or session stability. In some embodiments, post-launch demand and QoE metrics 932 are also provided to recommendation systems to improve future prelaunch recommendations, thereby forming a feedback loop that improves both recommendation and demand forecasting performance over time.

At step 1403, loss calculator 517 calculates loss 933 based on at-launch demand forecast 904 and post-launch demand and QoE metrics 932. In some embodiments, for a given live title i, loss calculator 517 computes a demand forecasting loss based on a difference between at-launch demand forecast 904 and observed post-launch demand included in post-launch demand and QoE metrics 932. For example, loss calculator 517 can compute a demand forecasting loss according to Equation 28. In some embodiments, loss calculator 517 further computes a QoE loss based on one or more QoE metrics included in post-launch demand and QoE metrics 932. For example, loss calculator 517 can compute a QoE loss according to Equation 29. In some embodiments, larger buffering rates, startup delays, playback failure rates, or reduced bitrate quality increase the QoE loss. In some embodiments, loss calculator 517 combines the demand forecasting loss and the QoE loss to generate a loss for each live title according to Equation 30. In some embodiments, loss calculator 517 aggregates the losses across multiple live titles to generate an overall loss 933, for example, according to L=Σᵢ Lᵢ.

At step 1404, model trainer 516 updates parameters of at-launch demand forecast model 522 based on loss 933. In some embodiments, for a given set of parameters θ of at-launch demand forecast model 522, model trainer 516 updates the parameters using an objective function derived from loss 933 according to Equation 31. In some embodiments, model trainer 516 applies one or more optimization techniques, including stochastic gradient descent, adaptive optimization methods, or regularization techniques, to improve convergence.

In sum, techniques are disclosed for generating recommendations and forecasting demands for prelaunch content. The disclosed techniques include one or more ranking models. Each of the one or more ranking models is a trained machine learning model that processes one or more prelaunch features and generates one or more ranking scores. In some embodiments, a training data generator processes upcoming live title metadata, content metadata, one or more content embeddings, one or more first cross content member interactions, and member metadata and generates one or more first candidate live titles, one or more prelaunch labels, and one or more anticipation rewards. The training data generator includes a prelaunch title detector, a candidate title generator, a prelaunch feature generator, a prelaunch content recommender, a prelaunch label generator, and an anticipation reward calculator. The prelaunch title detector detects one or more prelaunch live titles based on the upcoming live title metadata. The candidate title generator processes the prelaunch live titles, the first cross content member interactions, and the content embeddings and generates one or more first candidate live titles. The prelaunch feature generator processes the first candidate live titles, the first cross content member interactions, the content embeddings, the content metadata, and the member metadata and generates one or more first prelaunch features. The prelaunch content recommender uses the ranking models to process the first prelaunch features and the first candidate live titles and generates one or more first prelaunch content recommendations. The prelaunch label generator processes the first prelaunch content recommendations and one or more first prelaunch interaction signals and generates the prelaunch labels. The anticipation reward calculator processes the prelaunch labels and the content metadata and generates the anticipation rewards.

In some embodiments, a model trainer retrains the ranking models based on the content metadata, the member metadata, the content embeddings, the first cross content member interactions, the first candidate live titles, the prelaunch labels, and the anticipation rewards. During the retraining, the prelaunch feature generator processes the content metadata, the content embeddings, the first cross content member interactions, the member metadata, and the first candidate live titles and generates one or more second prelaunch features. The ranking models process the second prelaunch features and generate one or more ranking scores. A loss calculator calculates a first loss based on the ranking scores, prelaunch labels, and anticipation rewards. The model trainer uses the first loss to iteratively update one or more parameters of the ranking models until one or more stopping criteria are met. Once retrained, the retrained ranking models can be used via a prelaunch content recommendation application to generate one or more second prelaunch recommendations based on the member metadata, the content metadata, the content embeddings, one or more second cross content member interactions, and one or more second candidate live titles.

In some embodiments, a content delivery network (CDN) resource allocator uses an at-launch demand forecast model to process one or more second prelaunch interaction signals, the upcoming live title metadata, one or more historical similar events, one or more domain heuristics, and a CDN configuration and generates one or more allocated CDN resources. The at-launch demand forecast model is a trained machine learning model that processes one or more demand features and generates an at-launch demand forecast. In some embodiments, the CDN resource allocator includes a demand feature generator, an at-launch demand forecast module, an adjusted demand forecast generator, a CDN resource plan generator, and a CDN resource allocator. The demand feature generator processes the second prelaunch interaction signals and the upcoming live title metadata and generates the demand features. The at-launch demand forecast module uses the at-launch demand forecast model to process the demand features and generates the at-launch demand forecast and an at-launch demand distribution. The adjusted demand forecast generator processes the historical similar events and the domain heuristics and generates an adjusted demand forecast. The CDN resource plan generator processes the adjusted demand forecast and the CDN configuration and generates a CDN resource plan. The CDN resource allocator allocates CDN resources to live titles included in the upcoming live title metadata based on the CDN resource plan to generate the allocated CDN resources.

In some embodiments, the model trainer retrains the at-launch demand forecast model based on live launch telemetry and the at-launch demand forecast. During the retraining, a post-launch demand and quality of experience (QoE) metrics calculator calculates one or more post-launch demand and QoE metrics based on the live launch telemetry. The loss calculator calculates a second loss based on the at-launch demand forecast and the post-launch demand and QoE metrics. The model trainer updates one or more parameters of the at-launch demand forecast model based on the second loss.

At least one technical advantage of the disclosed techniques relative to prior art is that the disclosed techniques enable accurate recommendation and demand forecasting for newly introduced or prelaunch content by leveraging prelaunch interaction signals and time-dependent modeling. In particular, the disclosed techniques utilize prelaunch interaction signals, such as clicks, reminder registrations, and watchlist additions, together with content embeddings, member metadata, and cross content member interactions to train ranking models using anticipation rewards that account for temporal proximity to a launch time. Therefore, the disclosed techniques infer user interest for prelaunch content even in the absence of historical usage data and can adapt to distributional shifts associated with new content types, such as live events relative to on-demand content.

Another advantage of the disclosed techniques relative to prior art is that the disclosed techniques incorporate prelaunch interaction signals into demand estimation models to forecast viewership prior to content availability, which enables more accurate demand forecasting relative to approaches that rely solely on historical usage data. Further, by generating prelaunch content recommendations that increase prelaunch member engagement, the disclosed techniques increase the quantity and quality of prelaunch interaction signals available for demand estimation, hence further improving forecast accuracy. By combining model-based predictions with temporal weighting, quantile-based forecasting, historical-event adjustments, and domain-informed adjustments, the disclosed techniques improve the accuracy and robustness of demand forecasts and enable proactive allocation of CDN resources. More accurate demand forecasts, together with the domain-informed adjustments, further enable improved orchestration, provisioning, and operational planning for live events. Further, because the disclosed techniques generate demand features using aggregated prelaunch interaction signals and metadata rather than requiring large volumes of post-launch usage data, the disclosed techniques reduce computational complexity and enable demand forecasts to be generated more efficiently. Additionally, by allocating CDN resources prior to launch based on the demand forecasts, the disclosed techniques reduce over-provisioning and under-provisioning of network bandwidth, server capacity, and edge node resources, improve geographic distribution of CDN resources, and reduce latency, buffering, and network congestion during presentation of prelaunch content items.

These technical advantages provide one or more technological improvements over prior art approaches.

The following clauses describe aspects of the various embodiments.

1. In some embodiments, a computer-implemented method for generating recommendations for prelaunch content includes performing, via one or more trained machine learning models, one or more operations to generate one or more prelaunch labels and one or more anticipation rewards based on at least one or more first cross content member interactions, performing, based on at least the one or more prelaunch labels, the one or more anticipation rewards, and the one or more first cross content member interactions, one or more training operations to retrain the one or more trained machine learning models to generate one or more retrained machine learning models, and generating, via the one or more retrained machine learning models, one or more first prelaunch content recommendations based on at least one or more second cross content member interactions.

2. The computer-implemented method of clause 1, where performing the one or more operations to generate the one or more prelaunch labels and the one or more anticipation rewards includes generating, based on at least one or more prelaunch content recommendations and one or more prelaunch interaction signals, the one or more prelaunch labels, and generating, based on at least the one or more prelaunch labels and content metadata, the one or more anticipation rewards.

3. The computer-implemented method of clauses 1 or 2, further including determining, based on at least a launch time associated with each content item included in upcoming live titles metadata, one or more prelaunch live titles.

4. The computer-implemented method of any of clauses 1-3, further including computing, based on at least one or more content embeddings, one or more similarity scores, and retrieving, based on at least the one or more similarity scores, at least a subset of one or more live titles included in upcoming live titles metadata to generate one or more candidate live titles.

5. The computer-implemented method of any of clauses 1-4, where generating the one or more prelaunch labels includes assigning one or more weights to one or more interaction types included in the one or more prelaunch interaction signals to generate one or more weighted interaction types, and aggregating the one or more weighted interaction types to generate a scalar prelaunch label included in the one or more prelaunch labels.

6. The computer-implemented method of any of clauses 1-5, where generating the one or more prelaunch labels includes assigning a temporal weight to an interaction type included in the one or more prelaunch interaction signals that changes as an interaction time associated with a second prelaunch content recommendation approaches a launch time.

7. The computer-implemented method of any of clauses 1-6, where generating the one or more prelaunch labels includes in response to determining that at least one qualifying interaction included in the one or more prelaunch interaction signals is detected, assigning a first value to a first prelaunch label included in the one or more prelaunch labels, and in response to determining that no qualifying interaction included in the one or more prelaunch interaction signals is detected, assigning a second value to the first prelaunch label.

8. The computer-implemented method of any of clauses 1-7, where generating the one or more anticipation rewards includes calculating, based on at least a launch time associated with a candidate live title and an interaction timestamp, a temporal distance, and generating, via a reward function, a reward value based on at least the temporal distance.

9. The computer-implemented method of any of clauses 1-8, where performing the one or more training operations to generate the one or more retrained machine learning models includes calculating a loss based on at least one or more ranking scores generated by the one or more trained machine learning models, the one or more prelaunch labels, and the one or more anticipation rewards, and updating, based on at least the loss, one or more parameters of the one or more trained machine learning models.

10. The computer-implemented method of any of clauses 1-9, where calculating the loss includes calculating, based on at least the one or more ranking scores and the one or more prelaunch labels, one or more first losses, applying the one or more anticipation rewards as one or more multiplicative data weights to the one or more first losses to generate one or more weighted losses, and aggregating the one or more weighted losses to calculate the loss.

11. In some embodiments, one or more non-transitory computer-readable media include instructions that, when executed by one or more processors, cause the one or more processors to perform the steps of performing, via one or more trained machine learning models, one or more operations to generate one or more prelaunch labels and one or more anticipation rewards based on at least one or more first cross content member interactions, performing, based on at least the one or more prelaunch labels, the one or more anticipation rewards, and the one or more first cross content member interactions, one or more training operations to retrain the one or more trained machine learning models to generate one or more retrained machine learning models, and generating, via the one or more retrained machine learning models, one or more first prelaunch content recommendations based on at least one or more second cross content member interactions.

12. The one or more non-transitory computer-readable media of clause 11, where performing the one or more operations to generate the one or more prelaunch labels and the one or more anticipation rewards includes generating, based on at least one or more prelaunch content recommendations and one or more prelaunch interaction signals, the one or more prelaunch labels, and generating, based on at least the one or more prelaunch labels and content metadata, the one or more anticipation rewards.

13. The one or more non-transitory computer-readable media of clauses 11 or 12, where generating the one or more prelaunch labels includes assigning one or more weights to one or more interaction types included in the one or more prelaunch interaction signals to generate one or more weighted interaction types, and aggregating the one or more weighted interaction types to generate a scalar prelaunch label included in the one or more prelaunch labels.

14. The one or more non-transitory computer-readable media of any of clauses 11-13, where generating the one or more anticipation rewards includes calculating, based on at least a launch time associated with a candidate live title and an interaction timestamp, a temporal distance, and generating, via a reward function, a reward value based on at least the temporal distance.

15. The one or more non-transitory computer-readable media of any of clauses 11-14, where performing the one or more training operations to generate the one or more retrained machine learning models includes calculating a loss based on at least one or more ranking scores generated by the one or more trained machine learning models, the one or more prelaunch labels, and the one or more anticipation rewards, and updating, based on at least the loss, one or more parameters of the one or more trained machine learning models.

16. The one or more non-transitory computer-readable media of any of clauses 11-15, where calculating the loss includes calculating, based on at least the one or more ranking scores and the one or more prelaunch labels, one or more first losses, applying the one or more anticipation rewards as one or more multiplicative data weights to the one or more first losses to generate one or more weighted losses, and aggregating the one or more weighted losses to calculate the loss.

17. The one or more non-transitory computer-readable media of any of clauses 11-16, where the one or more trained machine learning models include at least one of a title ranking model that generates, based on at least one or more prelaunch features, a likelihood that a member engages with at least one of one or more candidate live titles, or a row ranking model that generates, based on at least the one or more prelaunch features, a ranking score associated with a relevance of a content row that includes the one or more candidate live titles.

18. The one or more non-transitory computer-readable media of any of clauses 11-17, where generating the one or more first prelaunch content recommendations includes generating one or more prelaunch features based on at least one or more candidate live titles, the one or more second cross content member interactions, member metadata, content metadata, and one or more content embeddings, and generating, via the one or more retrained machine learning models, the one or more first prelaunch content recommendations based on at least the one or more prelaunch features.

19. The one or more non-transitory computer-readable media of any of clauses 11-18, where generating the one or more first prelaunch content recommendations includes generating, via the one or more retrained machine learning models, one or more ranking scores based on at least the one or more prelaunch features, adjusting, based on at least one or more exploration parameters, the one or more ranking scores to generate one or more adjusted ranking scores, and selecting, via a bandit algorithm, a subset of one or more candidate live titles based on at least the one or more adjusted ranking scores to generate the one or more first prelaunch content recommendations.

20. In some embodiments, a system includes one or more memories that store instructions, and one or more processors that are coupled to the one or more memories and, when executing the instructions, performs the steps of performing, via one or more trained machine learning models, one or more operations to generate one or more prelaunch labels and one or more anticipation rewards based on at least one or more first cross content member interactions, performing, based on at least the one or more prelaunch labels, the one or more anticipation rewards, and the one or more first cross content member interactions, one or more training operations to retrain the one or more trained machine learning models to generate one or more retrained machine learning models, and generating, via the one or more retrained machine learning models, one or more first prelaunch content recommendations based on at least one or more second cross content member interactions.

21. In some embodiments, a computer-implemented method for generating content delivery network (CDN) resource plans includes receiving one or more prelaunch interaction signals associated with one or more prelaunch content items, generating, via a trained machine learning model, an at-launch demand forecast based on at least the one or more prelaunch interaction signals, adjusting the at-launch demand forecast based on at least one or more historical similar events and one or more domain heuristics to generate an adjusted demand forecast, generating, based on at least the adjusted demand forecast, a CDN resource plan, and allocating one or more CDN resources based on at least the CDN resource plan.

22. The computer-implemented method of clause 21, where generating the at-launch demand forecast includes generating, based on at least the one or more prelaunch interaction signals and metadata associated with the one or more prelaunch content items, one or more demand features, and generating, via the trained machine learning model, the at-launch demand forecast based on at least the one or more demand features.

23. The computer-implemented method of clauses 21 or 22, where generating the one or more demand features includes generating a feature vector that includes one or more aggregated interaction counts.

24. The computer-implemented method of any of clauses 21-23, where generating the one or more demand features includes assigning a first value to one or more watchlist additions included in the one or more prelaunch interaction signals and a second value to at least one of one or more clicks included in the one or more prelaunch interaction signals or one or more impressions included in the one or more prelaunch interaction signals.

25. The computer-implemented method of any of clauses 21-24, where the one or more demand features include an intensity of a viewer engagement with the one or more prelaunch content items included in the one or more prelaunch interaction signals and a temporal proximity to a launch time associated with the viewer engagement.

26. The computer-implemented method of any of clauses 21-25, further including generating, via a quantile regression technique, an at-launch demand distribution based on at least the at-launch demand forecast.

27. The computer-implemented method of any of clauses 21-26, where adjusting the at-launch demand forecast includes computing an adjustment value based on at least a viewer demand associated with the one or more historical similar events that share at least one characteristic with the one or more prelaunch content items.

28. The computer-implemented method of any of clauses 21-27, where adjusting the at-launch demand forecast includes determining, based on at least the one or more domain heuristics, at least one of a scaling factor or an offset factor, and applying the at least one of the scaling factor or the offset factor to the at-launch demand forecast to generate the adjusted demand forecast.

29. The computer-implemented method of any of clauses 21-28, where generating the CDN resource plan includes determining, based on at least the adjusted demand forecast and a CDN configuration, a network bandwidth and a number of CDN resource units.

30. The computer-implemented method of any of clauses 21-29, where allocating the one or more CDN resources includes allocating the one or more CDN resources across a plurality of geographic regions based on at least a demand distribution and a CDN configuration.

31. In some embodiments, one or more non-transitory computer-readable media include instructions that, when executed by one or more processors, cause the one or more processors to perform the steps of receiving one or more prelaunch interaction signals associated with one or more prelaunch content items, generating, via a trained machine learning model, an at-launch demand forecast based on at least the one or more prelaunch interaction signals, adjusting the at-launch demand forecast based on at least one or more historical similar events and one or more domain heuristics to generate an adjusted demand forecast, generating, based on at least the adjusted demand forecast, a content delivery network (CDN) resource plan, and allocating one or more CDN resources based on at least the CDN resource plan.

32. The one or more non-transitory computer-readable media of clause 31, where generating the at-launch demand forecast includes generating, based on at least the one or more prelaunch interaction signals and metadata associated with the one or more prelaunch content items, one or more demand features, and generating, via the trained machine learning model, the at-launch demand forecast based on at least the one or more demand features.

33. The one or more non-transitory computer-readable media of clauses 31 or 32, where the one or more demand features include an intensity of a viewer engagement with the one or more prelaunch content items included in the one or more prelaunch interaction signals and a temporal proximity to a launch time associated with the viewer engagement.

34. The one or more non-transitory computer-readable media of any of clauses 31-33, where generating the one or more demand features includes generating a feature vector that includes one or more aggregated interaction counts.

35. The one or more non-transitory computer-readable media of any of clauses 31-34, where generating the one or more demand features includes assigning a first value to one or more watchlist additions included in the one or more prelaunch interaction signals and a second value to at least one of one or more clicks included in the one or more prelaunch interaction signals or one or more impressions included in the one or more prelaunch interaction signals.

36. The one or more non-transitory computer-readable media of any of clauses 31-35, where the instructions, when executed by the one or more processors, further cause the one or more processors to perform the steps of receiving live launch telemetry associated with the one or more prelaunch content items, calculating, based on at least the live launch telemetry, a post-launch demand and one or more quality of experience metrics, calculating a loss based on at least the at-launch demand forecast, the post-launch demand, and the one or more quality of experience metrics, and updating, based on at least the loss, one or more parameters of the trained machine learning model.

37. The one or more non-transitory computer-readable media of any of clauses 31-36, where calculating the loss includes calculating, based on at least the at-launch demand forecast and the post-launch demand, a demand forecasting loss, calculating, based on at least the one or more quality of experience metrics, a quality of experience loss, and calculating, based on at least the demand forecasting loss and the quality of experience loss, the loss.

38. The one or more non-transitory computer-readable media of any of clauses 31-37, where computing the post-launch demand and the one or more quality of experience metrics includes computing a number of viewers that viewed a first prelaunch content item included in the one or more prelaunch content items during a time window subsequent to a live title launching.

39. The one or more non-transitory computer-readable media of any of clauses 31-38, where allocating the one or more CDN resources includes allocating the one or more CDN resources across a plurality of geographic regions based on at least a demand distribution and a CDN configuration.

40. In some embodiments, a system includes one or more memories that store instructions, and one or more processors that are coupled to the one or more memories and, when executing the instructions, perform the steps of receiving one or more prelaunch interaction signals associated with one or more prelaunch content items, generating, via a trained machine learning model, an at-launch demand forecast based on at least the one or more prelaunch interaction signals and metadata associated with the one or more prelaunch content items, adjusting the at-launch demand forecast based on at least one or more historical similar events and one or more domain heuristics to generate an adjusted demand forecast, generating, based on at least the adjusted demand forecast, a content delivery network (CDN) resource plan, and allocating one or more CDN resources based on at least the CDN resource plan.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating content delivery network (CDN) resource plans, the method comprising:
receiving one or more prelaunch interaction signals associated with one or more prelaunch content items;
generating, via a trained machine learning model, an at-launch demand forecast based on at least the one or more prelaunch interaction signals;
adjusting the at-launch demand forecast based on at least one or more historical similar events and one or more domain heuristics to generate an adjusted demand forecast;
generating, based on at least the adjusted demand forecast, a CDN resource plan; and
allocating one or more CDN resources based on at least the CDN resource plan.

2. The computer-implemented method of claim 1, wherein generating the at-launch demand forecast includes:
generating, based on at least the one or more prelaunch interaction signals and metadata associated with the one or more prelaunch content items, one or more demand features; and
generating, via the trained machine learning model, the at-launch demand forecast based on at least the one or more demand features.

3. The computer-implemented method of claim 2, wherein generating the one or more demand features includes generating a feature vector that includes one or more aggregated interaction counts.

4. The computer-implemented method of claim 2, wherein generating the one or more demand features includes assigning a first value to one or more watchlist additions included in the one or more prelaunch interaction signals and a second value to at least one of one or more clicks included in the one or more prelaunch interaction signals or one or more impressions included in the one or more prelaunch interaction signals.

5. The computer-implemented method of claim 2, wherein the one or more demand features include an intensity of a viewer engagement with the one or more prelaunch content items included in the one or more prelaunch interaction signals and a temporal proximity to a launch time associated with the viewer engagement.

6. The computer-implemented method of claim 1, further comprising generating, via a quantile regression technique, an at-launch demand distribution based on at least the at-launch demand forecast.

7. The computer-implemented method of claim 1, wherein adjusting the at-launch demand forecast includes computing an adjustment value based on at least a viewer demand associated with the one or more historical similar events that share at least one characteristic with the one or more prelaunch content items.

8. The computer-implemented method of claim 1, wherein adjusting the at-launch demand forecast includes:
determining, based on at least the one or more domain heuristics, at least one of a scaling factor or an offset factor; and
applying the at least one of the scaling factor or the offset factor to the at-launch demand forecast to generate the adjusted demand forecast.

9. The computer-implemented method of claim 1, wherein generating the CDN resource plan includes determining, based on at least the adjusted demand forecast and a CDN configuration, a network bandwidth and a number of CDN resource units.

10. The computer-implemented method of claim 1, wherein allocating the one or more CDN resources includes allocating the one or more CDN resources across a plurality of geographic regions based on at least a demand distribution and a CDN configuration.

11. One or more non-transitory computer-readable media including instructions that, when executed by one or more processors, cause the one or more processors to perform the steps of:
receiving one or more prelaunch interaction signals associated with one or more prelaunch content items;
generating, via a trained machine learning model, an at-launch demand forecast based on at least the one or more prelaunch interaction signals;
adjusting the at-launch demand forecast based on at least one or more historical similar events and one or more domain heuristics to generate an adjusted demand forecast;
generating, based on at least the adjusted demand forecast, a content delivery network (CDN) resource plan; and
allocating one or more CDN resources based on at least the CDN resource plan.

12. The one or more non-transitory computer-readable media of claim 11, wherein generating the at-launch demand forecast includes:
generating, based on at least the one or more prelaunch interaction signals and metadata associated with the one or more prelaunch content items, one or more demand features; and
generating, via the trained machine learning model, the at-launch demand forecast based on at least the one or more demand features.

13. The one or more non-transitory computer-readable media of claim 12, wherein the one or more demand features include an intensity of a viewer engagement with the one or more prelaunch content items included in the one or more prelaunch interaction signals and a temporal proximity to a launch time associated with the viewer engagement.

14. The one or more non-transitory computer-readable media of claim 12, wherein generating the one or more demand features includes generating a feature vector that includes one or more aggregated interaction counts.

15. The one or more non-transitory computer-readable media of claim 12, wherein generating the one or more demand features includes assigning a first value to one or more watchlist additions included in the one or more prelaunch interaction signals and a second value to at least one of one or more clicks included in the one or more prelaunch interaction signals or one or more impressions included in the one or more prelaunch interaction signals.

16. The one or more non-transitory computer-readable media of claim 11, wherein the instructions, when executed by the one or more processors, further cause the one or more processors to perform the steps of:
receiving live launch telemetry associated with the one or more prelaunch content items;
calculating, based on at least the live launch telemetry, a post-launch demand and one or more quality of experience metrics;
calculating a loss based on at least the at-launch demand forecast, the post-launch demand, and the one or more quality of experience metrics; and
updating, based on at least the loss, one or more parameters of the trained machine learning model.

17. The one or more non-transitory computer-readable media of claim 16, wherein calculating the loss includes:
calculating, based on at least the at-launch demand forecast and the post-launch demand, a demand forecasting loss;
calculating, based on at least the one or more quality of experience metrics, a quality of experience loss; and
calculating, based on at least the demand forecasting loss and the quality of experience loss, the loss.

18. The one or more non-transitory computer-readable media of claim 16, wherein computing the post-launch demand and the one or more quality of experience metrics includes computing a number of viewers that viewed a first prelaunch content item included in the one or more prelaunch content items during a time window subsequent to a live title launching.

19. The one or more non-transitory computer-readable media of claim 11, wherein allocating the one or more CDN resources includes allocating the one or more CDN resources across a plurality of geographic regions based on at least a demand distribution and a CDN configuration.

20. A system, comprising:
one or more memories that store instructions; and
one or more processors that are coupled to the one or more memories and, when executing the instructions, perform the steps of:
receiving one or more prelaunch interaction signals associated with one or more prelaunch content items;
generating, via a trained machine learning model, an at-launch demand forecast based on at least the one or more prelaunch interaction signals and metadata associated with the one or more prelaunch content items;
adjusting the at-launch demand forecast based on at least one or more historical similar events and one or more domain heuristics to generate an adjusted demand forecast;
generating, based on at least the adjusted demand forecast, a content delivery network (CDN) resource plan; and
allocating one or more CDN resources based on at least the CDN resource plan.
